(19) United States
(12) Patent Application Publication
(10) Pub. No.: US 2007/0287091 A1
(43) Pub. Date: Dec. 13, 2007

(54) System and method for exposing electronic substrates to UV light

(76) Inventors: Victor M. Jacobo, West Covina, CA (US); Raja D. Singh, Claremont, CA (US); Andre Soukasian, Venice, CA (US); David A. Jacobsen, Essex, MA (US); Frank E. Fabela, Upland, CA (US)

Correspondence Address: CHRISTIE, PARKER & HALE, LLP, PO BOX 7068, PASADENA, CA, 91109-7068, US

(21) Appl. No.: 11/451,983

(22) Filed: Jun. 12, 2006

(51) Int. Cl. G03C 1/52

(52) U.S. Cl. 430/154

(57) ABSTRACT

A flash lamp exposure system for exposing a substrate to ultraviolet radiation. The system includes at least one flash lamp, each of which includes: at least one lamp for emitting ultraviolet radiation in response to a voltage; at least one first reflector, each first reflector being adapted to reflect the ultraviolet radiation toward the substrate; a second reflector surrounding a path of the ultraviolet radiation from the at least one lamp to the substrate, the second reflector being adapted to reflect first rays of the ultraviolet radiation toward the substrate; and a third reflector disposed closer to the substrate than the secondary reflector and surrounding the path of the ultraviolet radiation from the at least one lamp to the substrate, the third reflector being adapted to reflect second rays of the ultraviolet radiation toward the substrate.

### FIELD OF THE INVENTION

The present invention relates to a system and method for rapidly exposing electronic substrates to ultraviolet light, and more particularly to a flash lamp exposure system that reduces photoresist curing time.

### BACKGROUND OF INVENTION

The exposure of photopolymer resists (i.e., photoresists) used in the fabrication of electronic substrates (e.g., for solder masks) requires tremendous amounts of energy at wavelengths at ultraviolet (UV) region of the spectrum (e.g., in the range of 350 nm to 450 nm). Light sources currently used for such UV light exposure include mercury xenon short arc lamps and metal halide extended arc lamps, that can require 30 to 40 seconds or more to expose such resists. This long exposure time is generally needed to deliver the approximately 200 to 800 milli-Joules (mJ) or more (e.g., more than 1000 mJ/cm²) of energy necessary to fully and properly expose high energy resists.

Furthermore, current systems are fragile, employ complicated shutter mechanisms to apply dosages and are comparatively low in power. The long exposure times and poor heat filtering of current systems add heat to the substrate, which compounds all the typical yield problems, including among others, solder mask sticking and the contribution to artwork thermal growth. This can also produce non-vertical side walls in the resist, which reduces resolution. Therefore, it is desirable to provide an apparatus and method for a system that allows for a rapid exposure of electronic substrates to UV light so that the speed of the exposures can be improved and heat production can be controlled.

### SUMMARY OF THE INVENTION

In an exemplary embodiment according to the present invention, a flash lamp exposure system for exposing a substrate to ultraviolet radiation is provided. The system includes at least one flash lamp, each flash lamp comprising: at least one lamp for emitting ultraviolet radiation in response to a voltage; at least one first reflector, each first reflector being adapted to reflect the ultraviolet radiation toward the substrate; a second reflector surrounding a path of the ultraviolet radiation from the at least one lamp to the substrate, the second reflector being adapted to reflect first rays of the ultraviolet radiation toward the substrate; and a third reflector disposed closer to the substrate than the secondary reflector and surrounding the path of the ultraviolet radiation from the at least one lamp to the substrate, the third reflector being adapted to reflect second rays of the ultraviolet radiation toward the substrate.

In another exemplary embodiment according to the present invention, a flash lamp for applying ultraviolet radiation to a substrate is provided. The flash lamp includes: a plurality of lamps for generating the ultraviolet radiation; at least one reflector for directing the ultraviolet radiation to the substrate; an energy storage unit for storing energy used to generate the ultraviolet radiation; an energy delivery unit for applying the stored energy to the lamps to generate the ultraviolet radiation; and a sequencer for controlling timing of light emission by the lamps.

In yet another exemplary embodiment according to the present invention, a method of exposing a substrate to ultraviolet radiation generated by a plurality of lamps is provided. The method comprising: storing energy used to generate the ultraviolet radiation; applying the stored energy to the lamps to generate the ultraviolet radiation; detecting energy of the ultraviolet radiation; and adjusting intensity of the ultraviolet radiation in accordance with the detected energy.

In yet another exemplary embodiment according to the present invention, a flash lamp discharge system includes: a lamp for emitting light; a trigger device for providing sufficient voltage to the lamp to initiate the lamp for light emission, wherein the lamp is located between the trigger device and a first ground; an energy storage device for storing energy used for the light emission; a switch located between the lamp and the energy storage device to selectively provide the energy to the lamp; and a biasing circuit for biasing the switch to prepare the switch to provide the energy to the lamp in response to a trigger signal applied to the switch, wherein the biasing circuit creates a potential difference across the switch without reference to the first ground.

These and other aspects of the invention will be more readily comprehended in view of the discussion herein and the accompanying drawings.

### BRIEF DESCRIPTION OF THE DRAWINGS

FIG. 1 is a partial perspective view of a system for exposing electronic substrates to ultraviolet light to cure photoresists (i.e., a UV light exposure system), according to one embodiment.

FIG. 2 is a schematic perspective view of a flash lamp exposure system that uses two flash lamps (also referred to as two sets of flash lamps or two flash lamp assemblies, when each lamp is referred to as a flash lamp), according to one embodiment.

FIG. 3 is a perspective view of a trigger transformer assembly for triggering the lamps to generate UV light, according to one embodiment.

FIG. 4 is a schematic perspective view of a reflector configuration in the flash lamp exposure system, according to one embodiment, in which the system further includes tertiary reflectors.

FIG. 5 is a schematic perspective view of a flash lamp exposure system, which utilizes only one flash lamp (i.e., one set of lamps) and corresponding reflectors, according to one embodiment.

FIGS. 6A, 6B, 6C and 6D respectively are a top view, a side view, another side view and a perspective view of secondary and tertiary reflectors, according to one embodiment.

FIG. 7 is a schematic sectional view of light reflections in a flash lamp having primary, secondary and tertiary reflectors.

FIG. 8 is a system block diagram of a flash lamp discharge system according to one embodiment of the present invention.

FIG. 9 is a schematic block diagram of the flash lamp discharge system of FIG. 8.

FIG. 10 is a circuit diagram of a 4-channel trigger transformer circuit of FIG. 9.

FIG. 11 is a circuit diagram of an 8-channel silicon controlled rectifier (SCR) controller of FIG. 9.

FIG. 12 is a schematic block diagram of an alternating current (AC) transformer board of FIG. 9.

FIG. 13 illustrates a schematic block diagram of a high voltage trigger board of FIG. 9.

FIG. 14 is a schematic partial circuit diagram of a single module including an energy storage unit and an energy delivery unit in a flash lamp discharge system, according to one embodiment.

FIG. 15A is an energy diagram illustrating lamp sequencing in which the lamps are discharged sequentially.

FIG. 15B is an energy diagram illustrating lamp sequencing in which the lamps are discharged substantially simultaneously (or concurrently).

FIG. 15C is an energy diagram illustrating lamp sequencing in which the lamps are discharged in a partially overlapped manner.

FIG. 16 is a schematic block diagram of a flash lamp discharge system, wherein each lamp can be energized by a plurality of storage capacitors in different modules, according to one embodiment.

FIG. 17 is a schematic partial circuit diagram of four modules, each module including an energy storage unit and an energy delivery unit for discharging four lamps, in a flash lamp discharge system, according to one embodiment.

FIG. 18 is a schematic circuit diagram of an SCR bias/gate trigger circuit of a flash lamp discharge system, according to one embodiment.

FIG. 19 is a schematic block diagram of an energy management control system (or energy management system) of a flash lamp discharge system, according to one embodiment.

FIG. 20 is a flow diagram illustrating application of ultraviolet radiation to a substrate, according to one embodiment.

### DETAILED DESCRIPTION

The present invention relates to a rapid exposure of photopolymer resists (i.e., photoresists) to ultraviolet (UV) radiation (i.e., UV light). More particularly, the present invention relates to a system and method for exposing an electronic substrate to UV light to cure the photoresists at a faster speed (e.g., takes 2 seconds) than the speed (e.g., takes 30 to 40 seconds) of the conventional systems. Although the present invention will be described hereinafter primarily in the context of exposing photopolymers to UV light during the production of electronic circuit boards, one skilled in the art would appreciate that the present invention is not limited thereto, and can be used in various other applications. Further, while the present invention is primarily applicable to solder mask applications to speed up the process, it is also suitable to other applications such as applications involving liquid resists or dry film.

In one exemplary embodiment in accordance with the present invention, a UV light exposure system (e.g., for curing photoresists) includes a flash lamp exposure system, in which two flash lamps are oriented facing each other with an exposure plane (on which a substrate or substrates are located) between them. This way, two substrates or two sides of one substrate can be concurrently exposed to UV light, thereby reducing curing time for the photoresist.

In one exemplary embodiment, the flash lamp exposure system includes primary, secondary and tertiary (or first, second and third) reflectors for reflecting the UV light toward the exposure plane.

In one exemplary embodiment, each flash lamp includes a plurality of lamps (e.g., four lamps) that can be emitted sequentially, substantially simultaneously (or concurrently) or in a partially overlapped manner using discharge sequencing electronics. The number, sequence and intensity of lamp emissions (or flashings) can be inputted by the user or can be calculated by the flash lamp discharge system (using a microcontroller) in accordance with the total energy requirement inputted by the user.

In one embodiment, one energy storage device is provided per lamp. In other embodiments, each lamp may be provided with two or more energy storage devices (e.g., high voltage capacitors) such that an interval between two UV light emissions of the same lamp can be reduced or minimized without incurring the expense of designing and fabricating a quick-charge energy storage device.

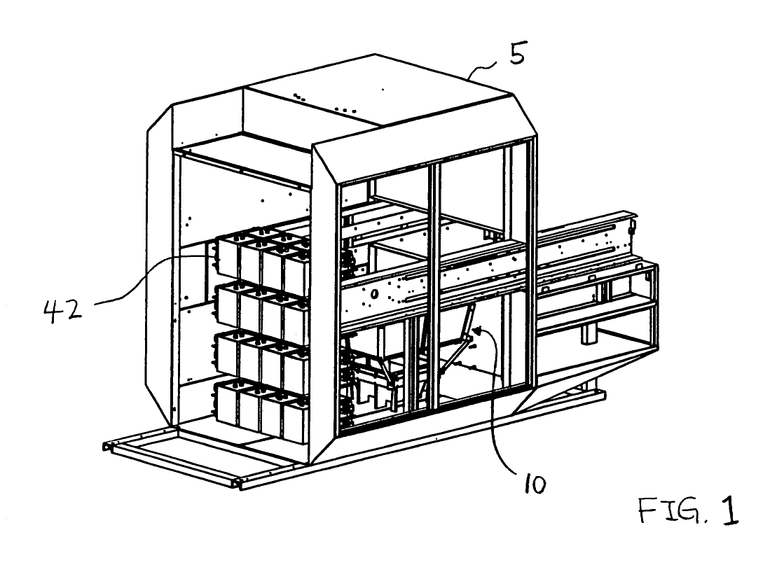

FIG. 1 is a partial perspective view of a UV light exposure system 5 in an exemplary embodiment in accordance with the present invention. The UV light exposure system includes a flash lamp exposure system 10 having one or more flash lamps. Each flash lamp includes one or more lamps and one or more reflectors to substantially uniformly apply the ultraviolet light generated by the lamps to a substrate located at an exposure plane. The UV light exposure system 5 includes a plurality of high voltage capacitors (HVCAPs) 42 that are used to store charges for illuminating the lamps. In one embodiment, more than one HVCAP is provided per lamp such that each lamp can be illuminated more than once during an interval, which is shorter than the time it takes to charge the HVCAP.

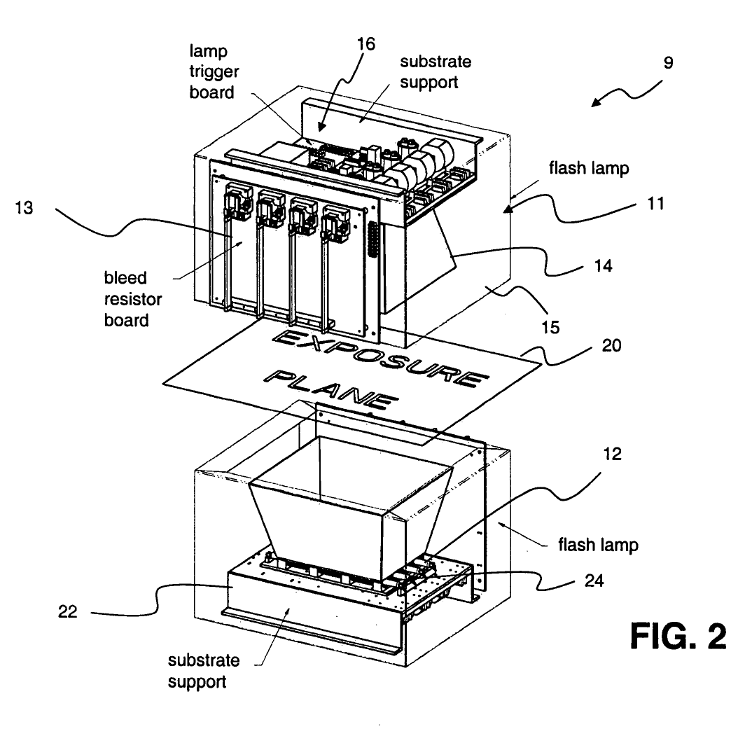

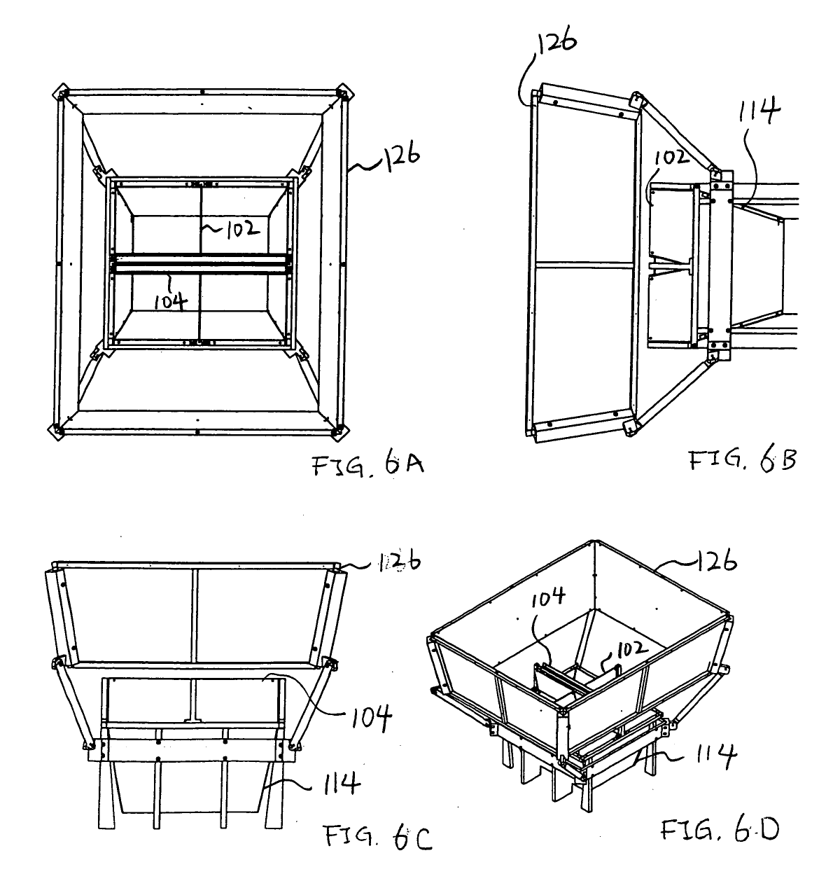

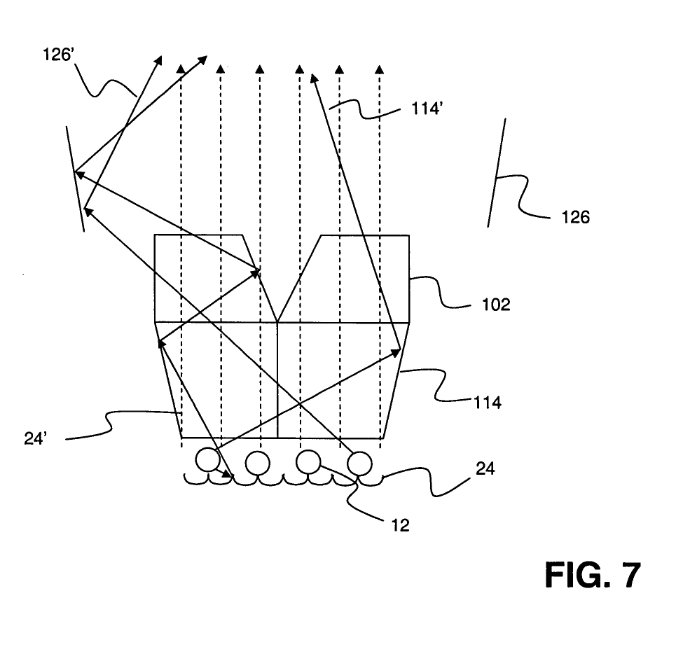

FIG. 2 is a schematic perspective view of a flash lamp exposure system 9. The flash lamp exposure system 9 is substantially the same as the flash lamp exposure system 10 of FIG. 1, except that the flash lamp exposure system 9 does not include tertiary reflectors (nor vanes as shown in FIGS. 6A-6D). Also, the shape of the secondary reflector may be different from that of the flash lamp exposure system 10 of FIG. 1.

The flash lamp exposure system 9 of FIG. 2 includes two flash lamps (or flash lamp assemblies) 11 that face each other and are substantially equidistant from an exposure plane 20 between them. As can be seen in FIG. 2, the first (or upper) flash lamp faces the exposure plane from the top, and the second (or lower) flash lamp faces the exposure plane from the bottom. A substrate (or substrates) to be exposed to UV light is placed on the exposure plane 20. The substrate loading, feeding and aligning process can be performed manually, automatically or semi-automatically. By way of example, in one embodiment, the substrate is loaded manually and fed in and aligned automatically. Those skilled in the art would know the method and equipment for placing and supporting the substrate or substrates at the exposure plane 20, and such method or equipment will not be discussed in detail herein. Because of the two flash lamps 11 that face the exposure plane 20 from top and bottom, respectively, two substrates or two sides of a same substrate can be exposed to the ultraviolet light substantially simultaneously or concurrently.

In one embodiment, each flash lamp (or flash lamp assembly) 11 includes four lamps (or flash lamps) 12; four primary reflectors 24; a secondary reflector 14; a control unit 16; and a substrate support 22 for supporting or mounting the control unit 16. The control unit 16 may include a microprocessor, a microcontroller and/or any other suitable logic circuitry for controlling the flash lamp exposure system. The number of lamps in the flash lamp is not limited to four, and the flash lamp may have more or less than four lamps in other embodiments. The control unit 16 and trigger circuitry are mounted on a lamp trigger board in the embodiment shown in FIG. 2. The control unit 16 and the trigger circuitry of the flash lamp 11 and the high voltage capacitors 42 may together be referred to as a “flash lamp discharge system” (with or without the power source(s)).

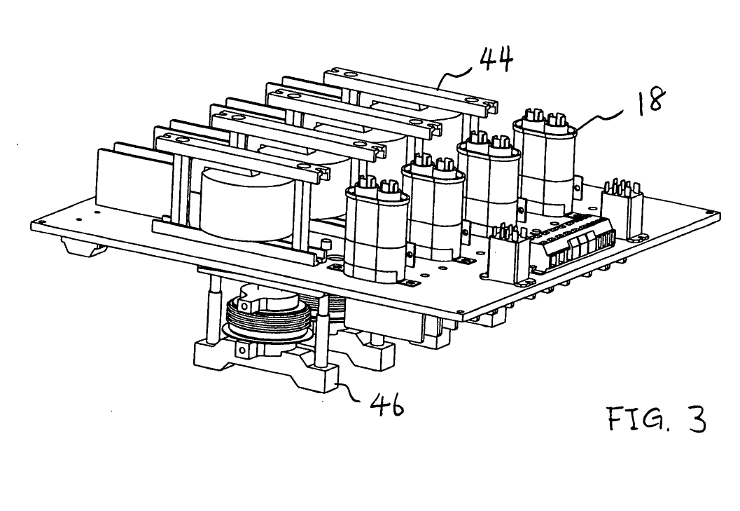

Referring now to FIG. 3, the trigger circuitry (or lamp trigger circuitry) in one embodiment is mounted or installed on a board separate from the control unit 16. The trigger circuitry in FIG. 3 includes trigger capacitors 18, a plurality of high voltage trigger transformers (HVTRIGs) 44 and a plurality of silicon controlled rectifiers (SCRs) 46. The HVTRIGs 44 and the trigger capacitors 18 are used to select the lamp to generate the UV light, whereas the SCRs are used to select the high voltage capacitor (or a capacitor bank) that supplies the energy to illuminate the lamp.

Referring back to FIG. 2, each flash lamp 11 includes a box-shaped housing 15. The housing 15 has an opening on the side facing the exposure plane 20 such that the ultraviolet light can be applied to the substrate on the exposure plane through the opening. While the flash lamp exposure system 9 of FIG. 2 indicates using a lamp trigger board (including the control unit 16) in each flash lamp 11, those skilled in the art would appreciate that both the upper and lower flash lamps 11 could share a single lamp trigger board (and/or power sources). In one embodiment, bleed resistors on a bleed resistor board 13 are used to drain high voltage storage devices (e.g., capacitors) for safety reasons when the system is powered off, but may not be used in other embodiments.

The lamp 12 is preferably a xenon flash lamp, which produces an intense peak of radiant energy when a high direct current (DC) pulsed voltage is applied between electrodes at opposite ends of the lamp tube. However, those skilled in the art would appreciate that any suitable lamp that is capable of emitting a high level of ultraviolet light in a short period of time can be used as the lamp 12. Also, in the described embodiment, the lamp 12 has an elongated cylindrical shape similar to conventional cylindrical fluorescent light tubes.

In other embodiments, other suitably shaped lamps having any suitable configuration may be used. For example, the lamps may have a configuration of an array or a matrix of flash lamps. In one embodiment, the flash lamp (or flash lamp assembly) includes one or more lamps (or flash lamps) arrayed such that the light is directed toward a collimating mirror (e.g., through a homogenizing fly's eye lens assembly (integrator)), whereby the light is reflected onto the substrate or directed at a collimating lens (e.g., through a homogenizing fly's eye lens assembly (integrator)), whereby the light is projected onto the substrate. In other embodiments, the homogenizing fly's eye lens assembly may not be used.

As can be seen in FIGS. 2, 4 and 5, each lamp 12 is adjacent one of the four primary reflectors 24. Each primary reflector 24 is arranged extending in a direction in which the lamp is elongated, and has a substantially involute cross section such that the light emitted by the lamp 12 toward the primary reflector 24 can be reflected by the inner surface of the primary reflector 24 so as to be applied to the substrate on the exposure plane 20 in a substantially uniform manner. Hence, each of the lamps 12 abuts (or is closely located to) a corresponding one of the primary reflectors 24, which are shaped to direct the light being emitted from the flash lamps towards the exposure plane 20. This configuration promotes a substantially uniform distribution of light to the surface of the substrate, such that the substrate is substantially evenly (or substantially uniformly) exposed to the ultraviolet light. Such substantially uniform application of ultraviolet rays in one embodiment is shown as light rays 24′ in FIG. 7, for example.

In one embodiment, the primary reflectors 24 are made of polished aluminum and coated to enhance reflectivity in the bandwidth of interest (e.g., 350 nm to 450 nm). In one embodiment, the material used to fabricate the primary reflectors 24 is Alanod 4270GP (formerly Miro2) which is basically a reflectorized aluminum designed to reflect light having a desired wavelength (e.g., bandwidth of interest) efficiently. In other embodiments, the primary reflectors 24 may be made of any other suitable material. The size and dimensional ratios of the primary reflectors 24 are designed using a ray tracing software known to those skilled in the art. In one embodiment, the flash lamp is designed for a maximum exposure area of 24 inches by 30 inches (approximately 61 cm×76 cm). The maximum exposure area, of course, may be larger in other embodiments.

Referring to FIGS. 2, 4 and 5, in the embodiments shown, each of the lamps 12 is doped with titanium. More specifically, lamp envelopes (i.e., the quartz) are doped with titanium. This helps to reduce or eliminate ultraviolet radiation having a wavelength below (or less than) 300 nano meter (nm). By reducing or eliminating the ultraviolet radiation being emitted at the wavelength below 300 nm, the production of unwanted ozone (O₃) is prevented or reduced in the flash lamp exposure system 9 (and 10, 10′ and 10″ respectively of FIGS. 1, 4 and 5).

The secondary reflector 14 has a general shape of a truncated pyramid having a rectangular base and four slanted side walls. The secondary reflector 14 has two rectangular openings, one at the base and the other one at the truncated side of the pyramid. The opening on the truncated side faces the lamps 12 while the opening at the base side faces the exposure plane 20. As such, the rectangular opening of the secondary reflector 14 that faces the lamps is smaller than the rectangular opening of the secondary reflector 14 that faces the exposure plane 20. The secondary reflectors 14 extend out from near the lamps 12, and are utilized to prevent light transmitted from the lamps 12 and primary reflectors 24 from escaping the line-of-sight of the exposure plane 20.

By reflecting the scattered or stray UV rays that are not normal to or incident on the exposure plane 20 toward the exposure plane 20, the secondary reflector captures energy that is otherwise wasted. This way, energy efficiency of the flash lamp (and therefore the energy efficiency of the flash lamp exposure system 9 or 10) is increased, thereby decreasing the photoresist curing time without increasing the light intensity or the exposure duration. Hence, energy waste is reduced and less heat is generated. Similar to the primary reflectors 24, the secondary reflectors 14 in one embodiment are designed using a ray tracing software and made of Alanod 4270GP. In other embodiments, the secondary reflectors 14 may be made of any other suitable material.

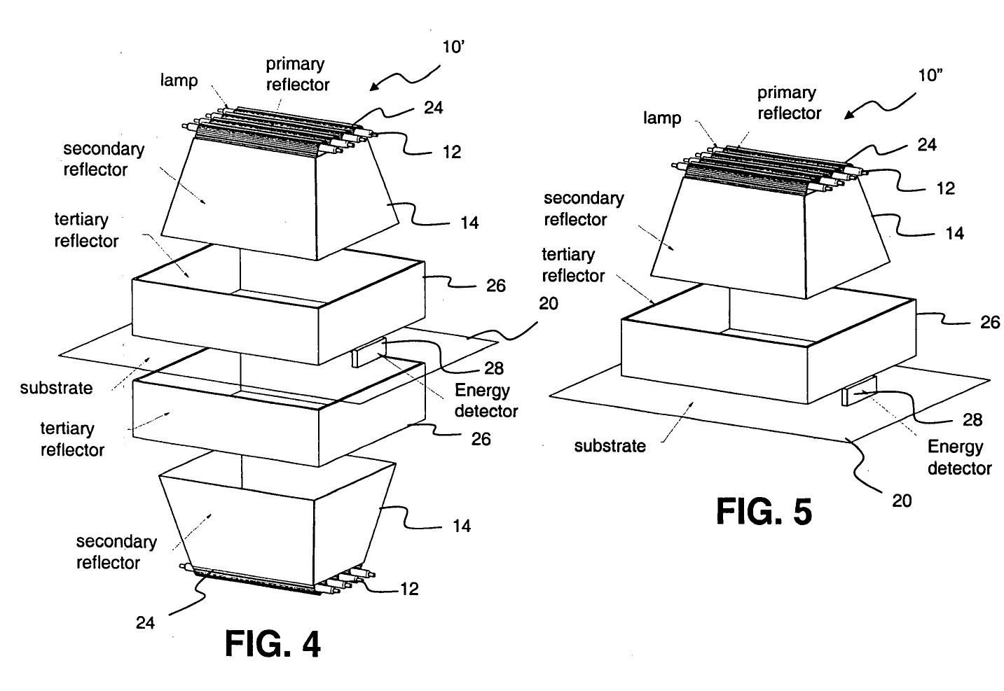

Referring now to FIG. 4, a flash lamp exposure system 10′ is substantially the same as the flash lamp exposure system 9 of FIG. 2, except that the flash lamp exposure system 10′ further includes tertiary reflectors 26. The components of the flash lamp exposure system 10′ that are substantially the same as the corresponding components of the flash lamp exposure system 9 of FIG. 2, will not be described again for the purpose of keeping the disclosure concise.

In one embodiment, each of the flash lamps 11 includes one of the box-shaped tertiary reflectors 26. In other embodiments, walls of the tertiary reflectors 26 may be slanted such that the tertiary reflectors also each have a shape similar to that of a cut-off pyramid, as shown in FIGS. 6A-6D. Each tertiary reflector 26 has two rectangular openings defined by four rectangular side walls. The rectangular openings face each other such that UV light from the lamps 12 can be passed through the openings to be applied at the substrate on the exposure plane 20. It can be said that the tertiary reflector 26 extends out from the secondary reflectors 14, and enclose the space between the secondary reflectors 14 and the exposure plane 20. As can be seen in FIG. 4, the tertiary reflector 26 does not abut the secondary reflector 14, but is spaced apart from the secondary reflector by a distance (or gap), which may be predetermined.

Separating the secondary and tertiary reflectors into two distinct units provides a benefit in some applications for material handling of the substrates. However, the tertiary reflector can effectively be integral to the secondary reflector in some other embodiments. Hence, in other embodiments, there may be no gap between the secondary and tertiary reflectors. In still other embodiments, the secondary reflectors and the tertiary reflectors may be fabricated as a single integrated unit. The tertiary reflectors 26 in one embodiment is made of Alanod 4270GP. In other embodiments, the tertiary reflectors 26 may be made of any other suitable material. Similar to the primary and secondary reflectors, the tertiary reflectors 26 may also be designed using a suitable ray tracing software known to those skilled in the art.

The tertiary reflectors 26 may be located 6 inches (approximately 15.24 cm) from the artwork for throughput of tray ride on a die-set. If a die-set is used, the tertiary reflector 26 may telescope from the secondary reflector 14. In such embodiment, the tertiary reflector may be mounted to a movable die-set while the secondary reflector is attached to the lamp head and is stationary. As the die-set opens and closes during operation, the ability to telescope allows for efficient capture of the light while allowing movement of mechanical components.

In the described embodiment, the placement of the tertiary reflectors 26 is configured to prevent any ultraviolet light rays, which are inadvertently redirected, away from the exposure plane 20 by the secondary reflectors 14, such that they are not being applied to (or incident on) the exposure plane 20, from escaping. In one embodiment, the lamps 12 are between a distance of 6 cm and 300 cm away from the exposure plane 20. In one embodiment, the height of the flash lamp exposure system is approximately 7 feet (about 213.4 cm). Through the use of folding mirrors, the length of the light path can be 200 inches (e.g., approximately 508 cm) in one embodiment. In other embodiments, the UV light applied to the substrate may be collimated.

The flash lamp in the flash lamp exposure system 10′ also includes an energy detector 28, which may also be referred to as an “energy gauge,” “black body energy gauge” or “energy sensor.” The energy detector 28, as shown in FIG. 4, is mounted on the tertiary reflector 26. The energy detector 28 is used to detect and/or measure the energy level (or light intensity) provided by the lamps 12 to the substrate on the exposure plane 20. In one embodiment, a thermopile is used as the energy detector 28 to measure energy by measuring the amount of heat generated by the UV radiation. In other embodiments, any other suitable detector or sensor (such as a photo detector, photo sensor, photo cell, radiometer or any other “light” sensor) may be used to measure the light intensity and/or the energy applied to the substrate on the exposure plane 20. Radiometers typically have a capability to integrate intensity of light over time to output energy, but not all radiometers can integrate the light intensity over a 4 millisecond light pulse.

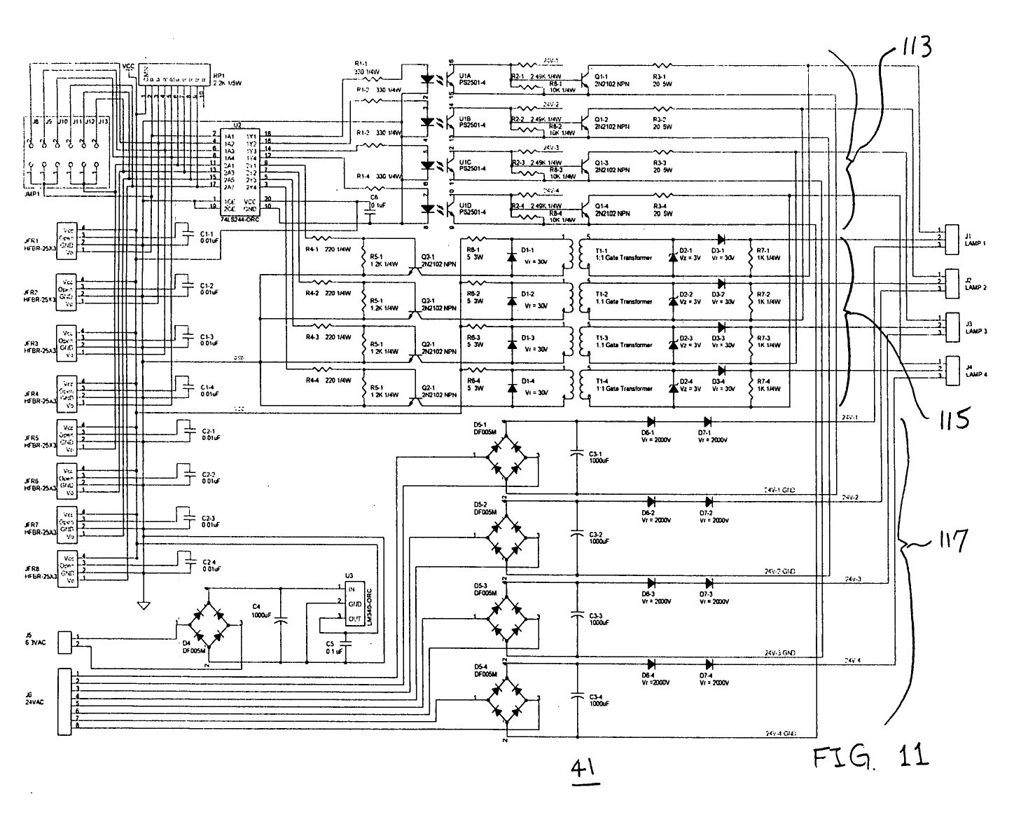

In one embodiment, a user enters energy requirement using a user interface (e.g., graphical user interface (GUI) 99 of FIG. 9) into the flash lamp exposure system. A control unit (e.g., including a microcontroller 50 of FIG. 9) converts the user's entered energy requirement into the necessary sequence and shot (or flash) count. Energy output information (e.g., heat or light intensity) detected by the energy detector 28 is provided to the control unit 16 (see FIG. 2), such that the applied energy/light intensity and/or timing of fire sequencing of the lamps 12 can be controlled automatically, semi-automatically and/or manually by the control unit 16 or the user based on the measured energy output. Also, using the energy output information, the exposure time of the substrate(s) on the exposure plane, light intensity of the lamps, and/or the interval between the lamp emissions (or flashes) can be determined and/or controlled.

While FIG. 4 shows that only the upper flash lamp has the energy detector 28 mounted on the tertiary reflector 26, in other embodiments, one or more energy detectors 28 may be mounted on the tertiary reflector 26 of the lower flash lamp or on the tertiary reflectors of both the upper and lower tertiary reflectors. Further, the energy detector(s) 28 may also be installed or located at any other suitable location in the flash lamp exposure system 10′.

A flash lamp exposure system 10″ of FIG. 5 is substantially the same as the flash lamp exposure system 10′ of FIG. 4, except that the flash lamp exposure system 10′ includes only a single flash lamp. Since only one flash lamp is provided, the flash lamp exposure system 10″ can be used to expose only one substrate or only one side of a substrate to the UV radiation at one time, therefore increasing time required to cure photoresists on two sides of a substrate or on multiple substrates. However, such flash lamp exposure systems having only a single flash lamp would result in cost savings for the UV light exposure system.

FIGS. 6A, 6B, 6C and 6D respectively show a top view, a side view, another side view and a perspective view of a secondary reflector 114 and a tertiary reflector 126 in one exemplary embodiment in accordance with the present invention. The reflector system of FIGS. 6A-6D also includes vanes 102 and 104. The vanes 102 and 104 are arranged between the secondary reflector 114 and the tertiary reflector 124 in directions that are substantially perpendicular to each other, such that they intersect with each other. The vanes 102 and 104 are used to further uniformize the ultraviolet light applied at the exposure plane. In one embodiment, the vane(s) or baffles are used to increase the uniformity over the exposure area and to improve the declination of the light reaching the exposure plane to achieve better results. In one embodiment, the secondary reflector 114, the tertiary reflector 126 and the vanes 102 and 104 are made of polished aluminum material such as Alanod 4270GP. In other embodiments, one or more of the reflectors and the vanes may be made of any other suitable material. In other embodiments, the vanes or battles may not be used.

In one exemplary embodiment, a suitable ray tracing software is used to design the secondary and tertiary reflectors 114 and 126. The ray tracing software may also be used to design the vanes 102 and 104. Those skilled in the art would know how to use the ray tracing software to select the locations and dimensions of the reflectors and vanes based on the disclosure of the present application.

As can be seen in FIG. 7, the primary reflectors 24 that are adjacent the respective lamps 12 have a substantially involute shape, such that they are used to direct the UV radiation emitted by the lamps 12 as substantially uniform UV radiation 24′ toward the exposure plane. Similarly, the UV rays that are not directed toward the exposure plane with or without being reflected by the primary reflectors are reflected by the secondary reflector 14 and/or the tertiary reflector 26 toward the exposure plane. As can be seen in FIG. 7, the UV rays 114′ and 126′ are reflected respectively by the secondary and tertiary reflectors 114 and 126 toward the exposure plane. The vanes 102 and 104 also contribute to the uniformization of the UV radiation applied to the exposure plane.

In one embodiment, the tertiary reflector 126 increases energy captured by 125%, which is more than double in actual measurement, thereby resulting in 125% increase in efficiency over the flash lamp exposure system 9 of FIG. 2, which only uses primary and secondary reflectors.

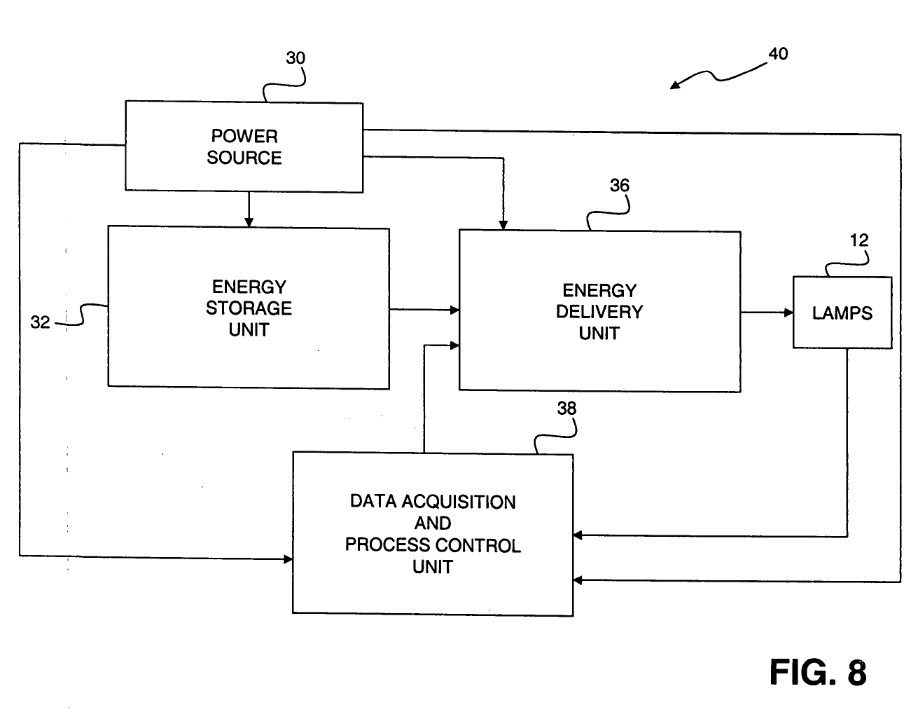

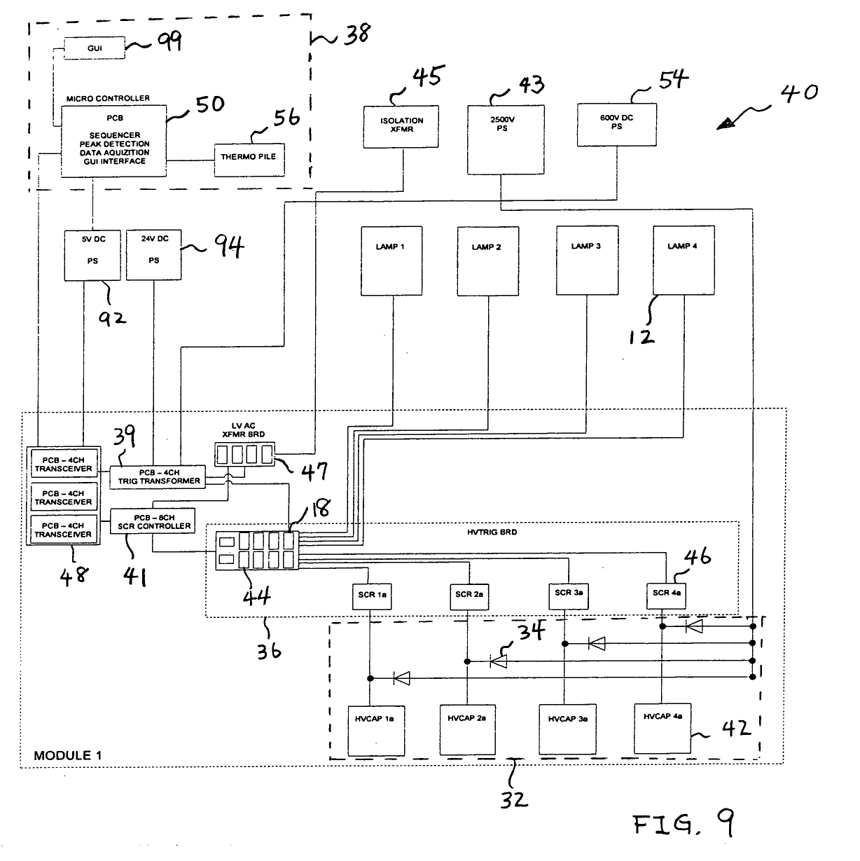

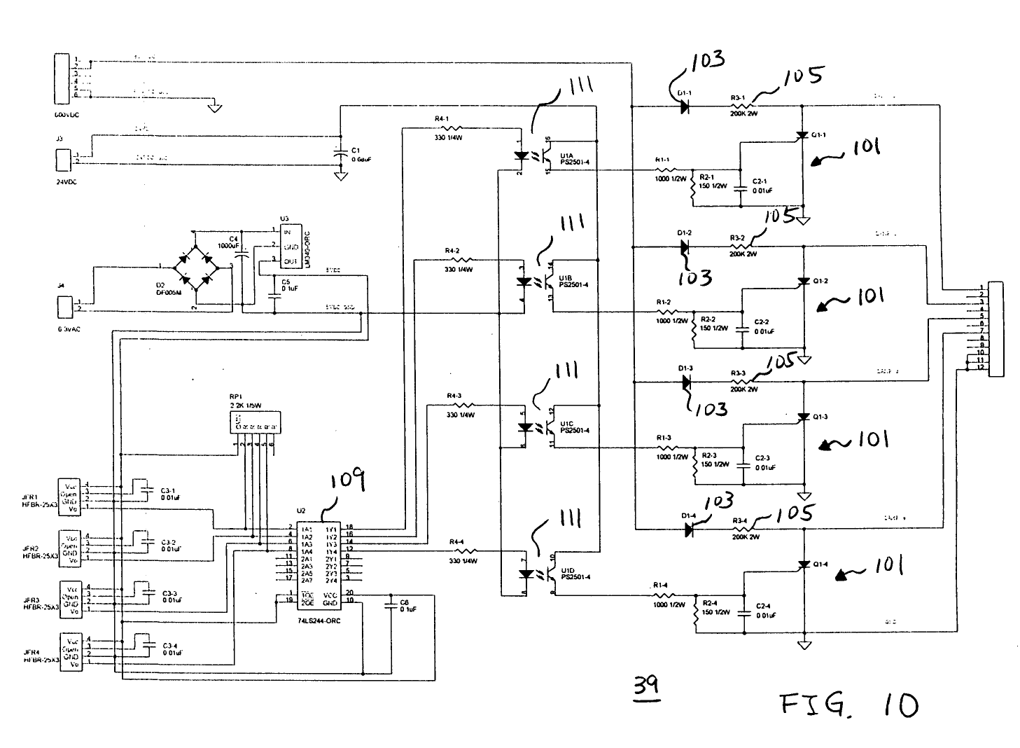

FIG. 8 is a system block diagram of a flash lamp discharge system 40 in an exemplary embodiment in accordance with the present invention. The flash lamp discharge system 40 includes lamps 12 that emit ultraviolet radiation as well as a power source and control/electronic circuitry used to provide energy to the lamps. The control/electronic circuitry of the flash lamp discharge system 40 also controls sequencing, delays, and the energy level of the UV radiation emitted by the lamps based on user input. In one embodiment, the control/electronic circuitry of the flash lamp discharge system 40 also includes a feedback mechanism for providing detected energy level that can be used to control the sequencing, delays and energy level of the UV radiation emitted by the lamps 12 to ensure that the actual energy output applied to the substrate corresponds to the desired energy output in accordance with the user input.

In one embodiment, the flash lamp discharge system 40 includes a power source 30, an energy storage unit (or system) 32, a discharge sequencing unit (or system) 34, an energy delivery unit (or system) 36, a data acquisition and process control unit (or system) 38 that includes the feedback mechanism, and lamps 12. The flash lamp discharge system 40 may also include other components that are not essential to the complete understanding of the invention depicted in FIG. 8, and therefore not shown in FIG. 8. Further, those skilled in the art would appreciate that the flash lamp discharge system in other embodiments may include other components that are suitable for flashing lamps in a controlled manner, instead of or in addition to the components shown in FIG. 8.

In one embodiment, the energy storage unit 32 includes one or more high voltage capacitors 42 (shown in FIG. 1, for example). The data acquisition and process control unit 38 may be substantially the same as the control unit 16 of FIG. 2. The flash lamp discharge system 40, except for the lamps 12, the power source 30, and the energy storage unit 32, may be implemented or installed on one or more printed circuit (PC) boards similar to the lamp trigger board of FIG. 2.

The power source 30 provides electrical energy to be stored in the energy storage unit 32 in a form of high voltage (e.g., 1,000 V to 2,500 V). The flash lamp discharge system 40 of FIG. 8 may, of course, include other power sources that are used to power its electronic circuitry. By way of example, the power source 30 supplies suitable power (i.e., electrical energy in a form of voltage and/or current) to the energy delivery unit 36, which is mounted on a high voltage trigger board in one embodiment (see FIG. 3 below), and the data acquisition and process control unit 38. Some of the components (e.g., power sources) of the power source 30 in one embodiment are illustrated below in FIG. 9.

The energy storage unit 32 stores the electrical energy provided by the power source 30, until the energy delivery unit 36 delivers or applies the stored electrical energy to one or more of the lamps 12. When the energy storage unit 32 includes a plurality of energy storage devices (e.g., high voltage capacitors), one or more of the energy storage devices may be selectively discharged to provide energy to the selected lamps, while other energy storage devices maintain their respective charges.

In one embodiment, the flash lamp discharge system has a modularized architecture, in which the energy storage unit 32 and the energy delivery unit 36 are implemented in a separate module. In such embodiment, a number of modules (or banks), each including the energy storage unit 32 and the energy delivery unit 36, can be used in a parallel architecture, such that each module can independently deliver electrical energy to emit the lamps. This way, intervals between light emission of each lamp can be reduced because the energy storage units in other modules can be used to store energy (or keep its stored energy) for a lamp, while one of the modules is being used to flash or emit that same lamp by discharging the corresponding energy storage device (e.g., high voltage capacitor) contained therein.

Using such independently chargeable energy storage units in a number of different modules, each lamp can be emitted repeatedly with substantially no interval or very little time interval between emissions. The number of times each lamp can be emitted within a short period of time depends on the number of energy storage units (i.e., the modules including the energy storage units) in the system. In one embodiment, one to four modules (or banks) can be used, where each module includes four energy storage devices (e.g., high voltage capacitors) respectively corresponding to four lamps.

The energy delivery unit 36 discharges electrical energy stored in the energy storage unit 32, thereby emitting ultraviolet radiation from the lamps, in response to control signals (e.g., discharge trigger signals) from the data acquisition and process control unit 38. The data acquisition and process control unit 38 in one embodiment receives as feedback a detected energy level (e.g., light intensity or heat) of light generated by the lamps 12, and uses the received feedback to control the energy delivery unit 36. The data acquisition and process control unit may include a microprocessor, a microcontroller and/or other programmable logic circuitry to implement the control and feedback functions.

FIG. 9 is a schematic block diagram of the flash lamp discharge system 40 of FIG. 8. As shown in FIGS. 8 and 9, the flash lamp discharge system 40 includes the energy storage unit 32, the energy delivery unit 36, the data acquisition and process control unit 38 and the lamps 12. In one embodiment, the power source 30 includes a number of different power sources to meet different voltage/current requirements of the components of the flash lamp discharge system 40. As shown in FIG. 9, the flash lamp discharge system 40 in one embodiment includes a 5V DC power source 92, a 24V DC power source 94, a 600 V DC power source 54 and an adjustable high voltage power source 43. In one embodiment, the adjustable high voltage power source 43 can selectively generate an output having an output voltage between 1,000 V and 2,500 V. Further, the 600 V DC power source 54 may provide an output having a voltage level between 400V and 600V.

In the embodiment shown in FIG. 9, the 2500V power source 43 is used to provide electrical energy to be stored in the energy storage unit 32. In other embodiments, the energy storage unit 32 may receive power from any other suitable power source to store it for the purposes of providing energy for the emission of lamps as those skilled in the art would appreciate.

The energy storage unit includes four energy storage devices (i.e., high voltage capacitors HVCAP 1a, HVCAP 2a, HVCAP 3a, HVCAP 4a) 42. The current from the 2500V power source 43 is provided to each of the high voltage capacitors 42 via a corresponding one of diodes 34. The input ends of the diodes 34 are electrically connected together and electrically connected to the 2500V power source 43. This way, when one of the high voltage capacitors 42 is being discharged, the current from that high voltage capacitor 42 is not inadvertently charged in one of the other high voltage capacitors 42.

In one embodiment, the high voltage capacitor 42 has a capacitance of 1450 μF. However, the invention is not limited thereto, and one skilled in the art would appreciate that any suitable high voltage capacitor capable of storing sufficient energy for generation of a high energy ultraviolet light could be used. By way of example, each high voltage capacitor 42 in one embodiment can store a maximum of 2,500 V, where at least 1,000 V is needed to flash a lamp. The energy for emitting light from a lamp is stored or charged in a corresponding one of the high voltage capacitors 42 and then is rapidly transferred to its corresponding lamp 12 when the lamp 12 is activated or triggered through applying a high voltage between its electrodes using a high voltage trigger transformer 44.

In one embodiment, each lamp 12 has at least one corresponding high voltage capacitor 42, which stores the energy and then discharges the energy for application to the corresponding lamp 12. The discharge of the high voltage capacitor 42 is initiated using the high voltage trigger transformer 44 in the energy delivery unit 36 (on the high voltage trigger board). The high voltage trigger transformer 44 places a high voltage across the lamp 12 at the moment of activation. In one embodiment, the voltage applied by the high voltage trigger transformer 44 is at least 20,000 volts. In one embodiment, the high voltage trigger transformer 44 is controlled by a 4-channel trigger transformer circuit 39 (e.g., on a PCB), which responds to control signals provided by the data acquisition and process control unit 38 through a 12-channel transceiver circuit 48. The 12-channel transceiver circuit 48 includes three 4-channel transceivers (e.g., on separate PCBs) in one embodiment. In other embodiments, the 12-channel transceiver circuit 48 may include a single transceiver device having 12 channels.

The 12-channel transceiver circuit 48 is optically isolates the data acquisition and process control unit 38 from circuitry that handles higher voltage such as the trigger transformer circuit 39. In one embodiment, the microcontroller 50 provides one or more lamp trigger signals to the trigger transformer circuit 39 through the transceiver circuit 48. The lamp trigger signal is used to close a switch which grounds a trigger capacitor 18 which is charged up to 600 Vdc, and places in series with the high voltage trigger transformer 44. When grounded, the trigger capacitor 18 creates an instantaneous voltage drop across the high voltage trigger transformer 44 which bumps the voltage up to 30,000V on its secondary side (i.e., across its secondary coil).

The energy dose provided to the exposure plane 20 can be varied by varying the charge on the high voltage capacitors 42 or the number of flashes (or pulses) applied. Such variation of the charge or the number of flashes can be performed automatically by the microcontroller 50 using the user's input of the total energy output requirement. The exposure area can be varied widely by adjusting light intensity and/or by adjusting reflectors. By way of example, the dimensions of the exposed area can be 24″ by 30″ (approximately 61 cm×76.2 cm) or 25″ by 31″ (approximately 63.5 cm×78.7 cm) in one embodiment.

Four silicon controlled rectifiers (SCRs) (i.e., SCR 1a, SCR 2a, SCR 3a, SCR 4a) 46 are used to selectively provide energy from the high voltage capacitors 42 to the respective lamps (Lamp 1, Lamp 2, Lamp 3, Lamp 4) 12 upon receiving biasing voltages and one or more gate trigger signals from an 8-channel SCR controller circuit 41 (on a PCB).

In other embodiments, insulated gate bipolar transistors (IGBTs) are used instead of SCRs for switching different high voltage capacitors and/or capacitor banks at millisecond switching speeds. In still other embodiments, any other suitable high speed switches may be used to select and discharge the high voltage capacitors 42 to provide light emission (or flashing) energy to the lamps.

The data acquisition and process control unit 38 includes the microcontroller 50, a thermopile 56, and a graphical user interface (GUI) 99. The microcontroller 50 may be any suitable microcontroller known to those skilled in the art. In other embodiments, a microprocessor or any other suitable logic circuitry may be used instead of the microcontroller 50. The microcontroller 50 is preferably mounted on a PCB and has one or more functions of sequencing, peak detection, data acquisition and GUI interface. These components and functions will be described in detail later.

In one embodiment, the trigger transformer circuit 39 is used to select which lamp 12 to illuminate, and the SCR controller circuit 41 is used to select which high voltage capacitor 42 discharges through the lamp. When the trigger capacitor 18 is charging, the high voltage trigger transformer 44 acts simply as a coil of wire in the circuit. The 20-30KV the high voltage trigger transformer 44 produces is provided to the lamp prior to the high voltage capacitor 42 discharging. The high voltage created by the transformer 44 excites the lamp and causes it to create a connection to ground. Once the lamp creates a path to ground, the main capacitor (high voltage capacitor) 42 sees a path to ground and immediately discharges.

FIG. 10 is a circuit diagram of a 4-channel trigger transformer circuit 39 of FIG. 9 in one embodiment in accordance with the present invention. The 4-channel trigger transformer circuit 39 receives power from the 600V DC power source 54, and charges the received energy in the trigger capacitors 18 through respective diodes 103 and resistors 105. The trigger transformer circuit 39 receives one or more lamp trigger signals from the data acquisition and process control unit 38 through fiber optical cables and the 12-channel transceiver circuit 48.

The 4-channel trigger transformer circuit 39 includes buffer/line drivers 109 that receive the lamp trigger signals and provide them to respective switches 101 through respective optical isolators 111. The switch 101 turns on in response to the lamp trigger signal, and electrically connects the higher potential electrode of the corresponding trigger capacitor 18 to ground. At this time, current flows through the primary coil of the high voltage trigger 44, and a high voltage (e.g., 20,000 to 30,000 volts) generated at the secondary coil of the high voltage trigger 44 is applied across the electrodes of the corresponding lamp 12. In one embodiment a ratio between the primary and secondary coils is 1:50 such that the voltage of 400V to 600V charged in the trigger capacitor 18 is converted to 20,000V to 30,000V on the secondary coil side.

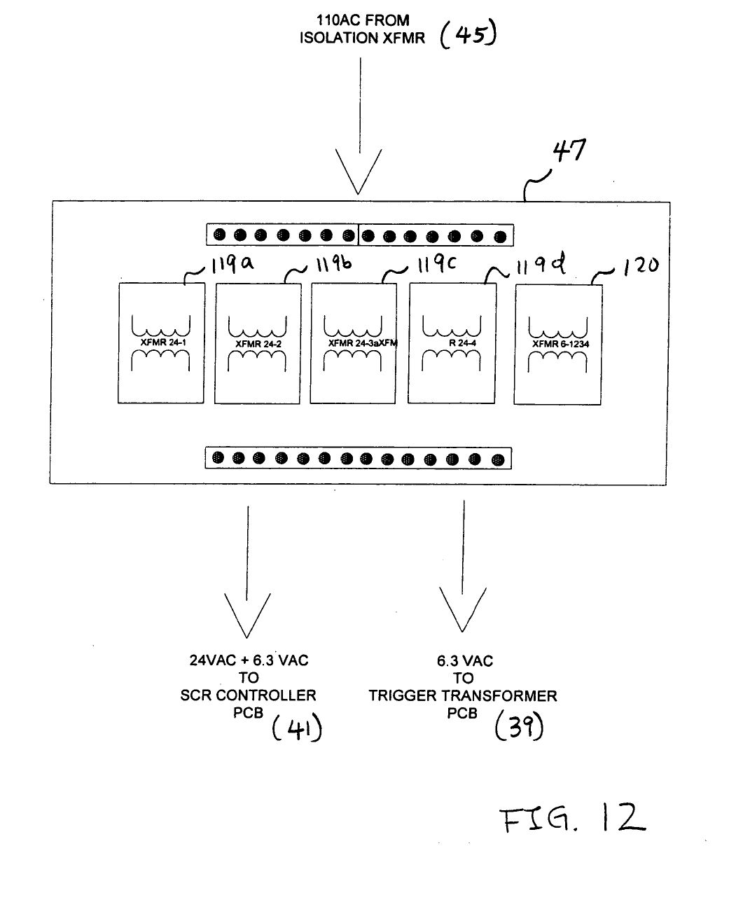

FIG. 11 is a circuit diagram of an 8-channel silicon controlled rectifier (SCR) controller circuit 41 of FIG. 9, according to one embodiment. The 8-channel SCR controller circuit 41 includes four channels 115 for providing gate trigger signals at respective gates of the SCRs 46, and four channels 113 for providing bias at the cathode of the respective SCRs 46. Both the gate trigger signals applied at the gates of the SCRs and bias signals for proving bias at the cathode of the respective SCRs 46 are provided by the data acquisition and processing control unit 38, and received by the 8-channel SCR controller circuit 41 through fiber optic cables and the 12-channel transceiver circuit 48. The 8-channel SCR controller circuit 41 also receives 24V AC, rectifies the 24V AC, and provides the 24V DC voltage to anodes of the SCRs 46, as can be seen in voltage application paths 117. Since there typically is a voltage drop during rectifying, the 24V AC in practice may have a voltage level higher than 24V (e.g., 28V AC).

FIG. 12 is a schematic block diagram of the AC transformer board 47 of FIG. 9. The AC transformer board 47 receives 110V AC through the isolation transformer 45, and converts them to 24V AC and 6.3V AC using 24V transformers 119a, 119b, 119c, 119d and a 6.3V transformer 120. Since the 24V AC voltage is rectified (e.g., in the 8-channel SCR controller circuit 41) to 24V DC, in practice, the 24V AC voltage may have a higher voltage level (e.g., 28V AC). The 24V AC voltage and the 6.3V AC voltage are provided to the 8-channel SCR controller circuit 41. The 6.3V AC voltage is also provided to the 4-channel trigger transformer circuit 39.

In one embodiment, a high quality (e.g., medical grade) transformer is used as the isolation transformer 45. Due to the high cost, in one embodiment, only one isolation transformer 45 is used for the entire flash lamp discharge system. The 24V transformers 119a-d used are typically less expensive, and in one embodiment, one 24V transformer is provided per lamp.

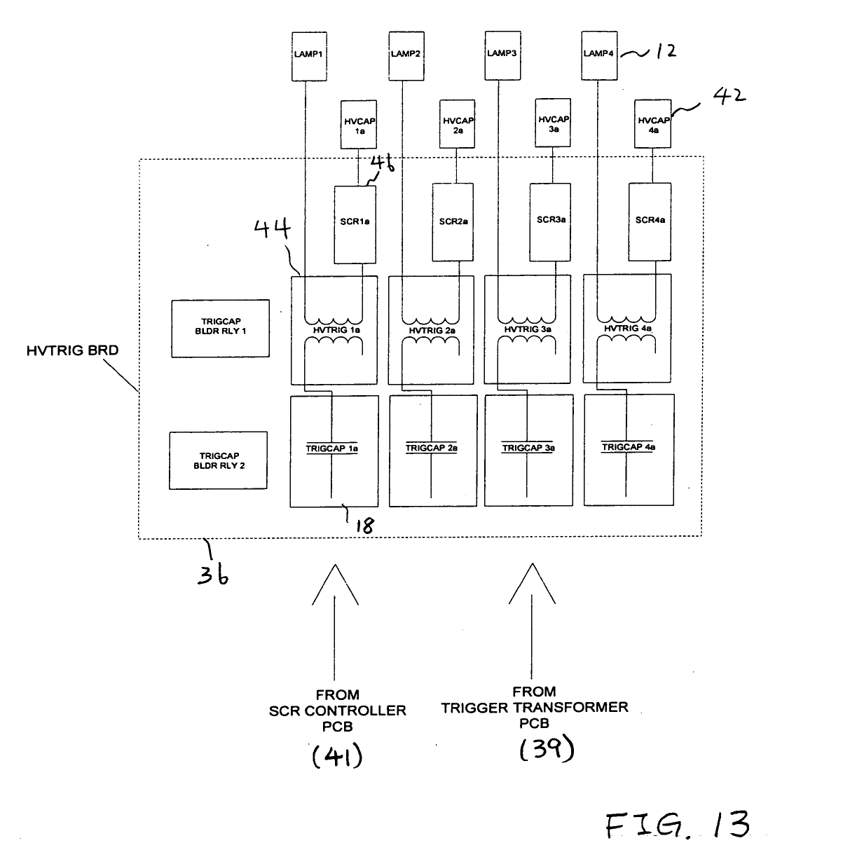

FIG. 13 is a schematic block diagram of the energy delivery unit 36 mounted on the high voltage trigger board of FIG. 9. The energy delivery unit 36 in one embodiment includes four SCRs 46 for providing energy from the respective high voltage capacitors 42 to the respective lamps 12, in response to the gate trigger signals from the SCR controller circuit 41. The energy delivery unit 36 in one embodiment also includes four high voltage triggers 44 and four trigger capacitors 18 for triggering the respective lamps 12 to emit UV radiation by applying a high voltage (e.g., 20,000 to 30,000 V) across the respective lamps 12, in response to the lamp trigger signals received at the trigger transformer circuit 39.

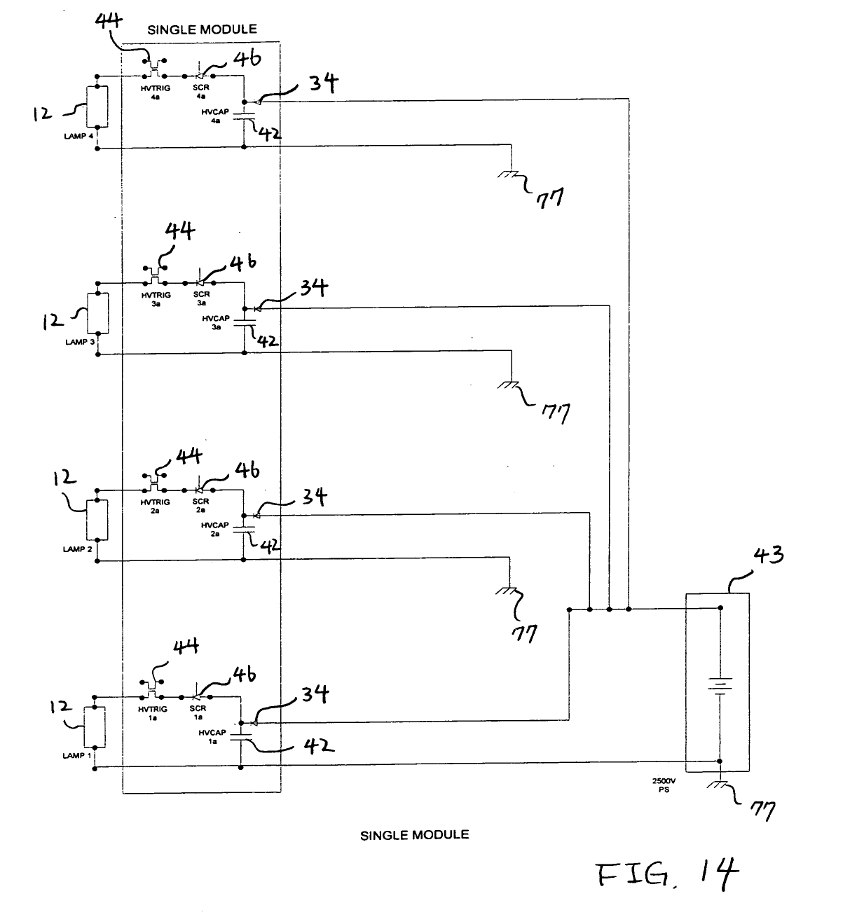

The light emission process can perhaps be better described in reference to a schematic partial circuit diagram of the energy storage unit and the energy delivery unit in FIG. 14. In one embodiment, the high voltage power source (i.e., 2500V power source) 43 is used to charge the high voltage capacitor 42 corresponding to each of the lamps 12. The high voltage power source 43 is electrically connected to earth ground 77 in the described embodiment. While FIG. 14 illustrates four lamps 12 and circuits for emitting the four lamps, since the circuits for emitting the lamps are substantially the same as one another, the schematic partial circuit diagram of FIG. 14 will be described in reference to one of the lamps only.

Referring now to FIGS. 9 and 14, a second electrode (e.g., low potential end) of the high voltage capacitor 42 and a second electrode of the lamp 12 are electrically connected to the earth ground 77. A first electrode (e.g., high potential end) of the high voltage capacitor 42 is coupled to a first electrode of the lamp 12 via the SCR 46 and a high voltage trigger transformer 44. The SCR 46 has an anode electrically connected to the first electrode of the capacitor 42, a gate electrically connected to the SCR controller circuit 41, and a cathode electrically connected to the secondary coil of the high voltage trigger transformer 44. The primary coil of the high voltage trigger transformer 44 is electrically connected to a trigger capacitor circuit including the trigger capacitor 18 as illustrated in FIG. 18. Each of the high voltage capacitors 42 receives power (or energy or current) for charging the capacitor from the power source 43 through one of the diodes 34.

In one embodiment, the SCR 46 is configured such that it conducts and applies the voltage supplied at its anode to its cathode when the voltage difference between the gate and the cathode is at least a predetermined voltage (e.g., 3V). Therefore, when the high voltage trigger transformer 44 selects a particular lamp by applying a pulse of very high voltage (e.g., 20,000 volts) to the first terminal of the lamp 12, and the SCR controller circuit 41 applies the gate trigger signal to the gate of the SCR 46, the SCR 46 applies the energy (e.g., having 2,500 volts) stored in the high voltage capacitor 42 to the lamp 12. This way, the high voltage capacitor 42 is discharged, and the lamp 12 emits ultraviolet light.

Returning now to FIG. 9, in one embodiment, the microcontroller 50 is programmed with logic to control the discharge cycle of the high voltage capacitors 42. In other embodiments, the logic may be implemented through individual logic gates and/or programmable logic devices in other embodiments. In one embodiment, the programmable logic devices may include complex programmable logic device (CPLD) and/or field programmable gate array (FPGA) units. These units can be thought of as a collection of logic gates which can be configured in various ways, and those skilled in the art would know how to program and use CPLD and FPGA to implement suitable logic to practice the described embodiments of the present invention based on the disclosure herein.

A typical average propagation delay time in CPLD and FPGA is 7 nanoseconds which generally leads to a very accurate system. In one embodiment, a timing circuit allows for user adjustment of the time delays between the flashes of the lamps 12. The timing circuit further allows for adjustment of the number of flashes of each of the lamps 12. Hence, using the flash lamp discharge system 40 of FIGS. 8 and 9, a number of different sequencing of light emission from the lamps 12 can be realized.

In one embodiment, the timing circuit allows for user adjustment of: a) a time delay between successive shots (flashes or emissions) of the first lamp (lamp 1); b) a time delay between shots of the first lamp (lamp 1), the second lamp (lamp 2), the third lamp (lamp 3) and the fourth lamp (lamp 4); and c) a number of shots or flashes. These three parameters (and/or any other parameters) can be pre-programmed in the microcontroller 50 (which may control the entire process) in the data acquisition and process control unit 38 or may be inputted by the user via the GUI 99.

In one embodiment, these and other parameters are calculated by the microcontroller in accordance with the desired total energy output inputted by the user. In this embodiment, the microcontroller 50 determines all system functions such as time delays, light intensities, number of flashes, etc. according to the user input of the desired total energy output.

In other embodiments, a control cycle is commenced as the microcontroller 50 receives as input the number of flashes (or shots) required. Then the time delay required between successive flashes of the first lamp 12, and the time delay required between flashes of the first, second third and fourth lamps 12 are provided to the microcontroller 50. In other embodiments, any other suitable delay parameters may be inputted or programmed into the microcontroller 50.

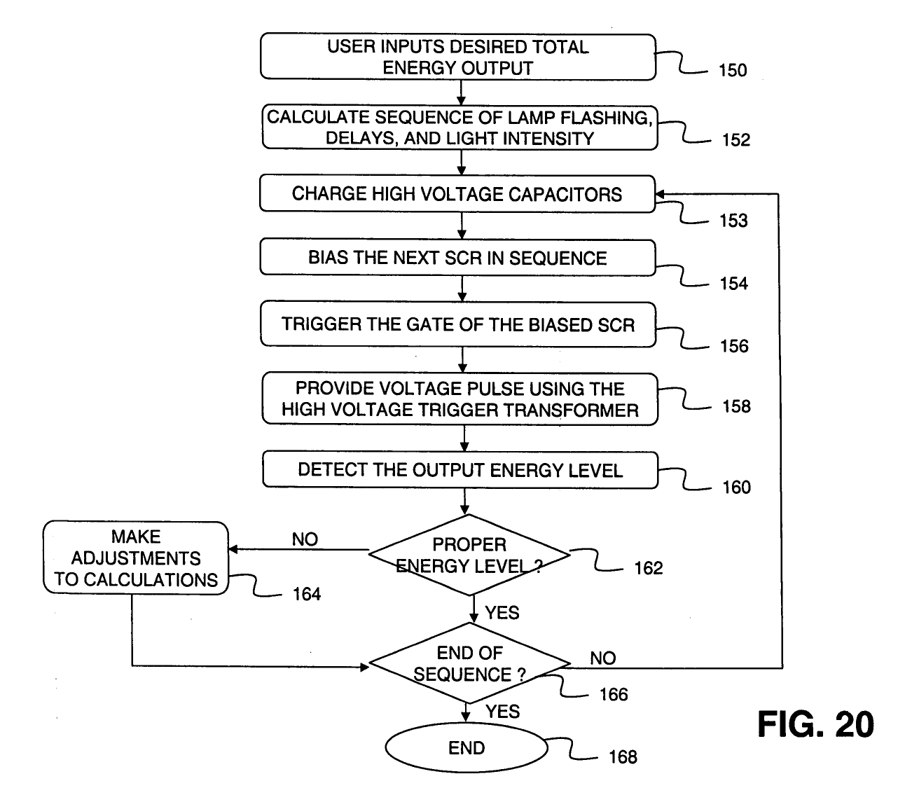

In one embodiment, after the number of flashes and time delay information are inputted into the microcontroller 50, the microcontroller 50 waits for an expose input, which begins the turning on of the lamps. The “lamp turning on process” in one embodiment includes: a) biasing of the selected silicon controlled rectifier 46; b) triggering the gate of the selected silicon controlled rectifier 46; and c) pulsing the high voltage trigger transformer (HVTRIG) 44 as shown in FIG. 20.

The above steps in one embodiment can be run concurrently or substantially simultaneously for all four lamps 12 or sequentially. In one embodiment, the time delays are calculated by the microcontroller based on the total energy output requirement inputted by the user. In other embodiments, the time delays (in addition to one or more other parameters such as number of flashes, light intensity of each flash, etc.) are set by setting the time delay between the flashing of the subsequent or adjacent lamps. For example, if the time delay is set to be 0, it means that there is no delay between the first lamp and other lamps. Further, if the time delay is set to a number such as 10, that would mean that: the process would be initiated for the second lamp 10 ms after it was initiated for the first lamp; the process would be initiated for the third lamp 10 ms after it was initiated for the second lamp; and the process would be initiated for the fourth lamp 10 ms after it was initiated for the third lamp. The variable (e.g., programmable) time delays between the flashing or emission of subsequently flashed lamps may be 1 to 100 ms in one exemplary embodiment.

If each of the plurality of lamps 12 is set in the microcontroller 50 to only flash once, the process ends after the final lamp in the sequence flashes and the microprocessor 50 awaits further instruction. On the other hand, if the number of flashes is set to 2 or higher, the microcontroller 50 runs through the initial sequence and then after the final lamp 12 has flashed, the microcontroller 50 directs the high voltage capacitor 42 to cease discharging until the inputted delay period (e.g., time delay between the subsequent flashes of the first lamp) passes and the process is reinitiated. This process will loop until the required number of flashes have occurred in one embodiment. Of course, any other suitable time delay/sequencing schemes may be used in other embodiments.

In one embodiment, in order to avoid possible EMI interference with the microcontroller 50, the 12-channel transceiver circuit 48 is used to optically isolate the microcontroller 50 from the EMI and high voltage elements of the module 1 (see FIG. 9) of the flash lamp discharge system 40. The 12-channel transceiver circuit 48 and fiber optic cables are used to send and receive control signals from the microcontroller 50 as optical signals by the trigger transformer circuit 39 and the SCR controller circuit 41. This way, low voltage elements can be optically isolated from the rest of the flash lamp discharge system 40. The optical isolation reduces or eliminates noise in one embodiment. A great care should be taken to make certain that there are no electrical ground loops in the system in one embodiment.

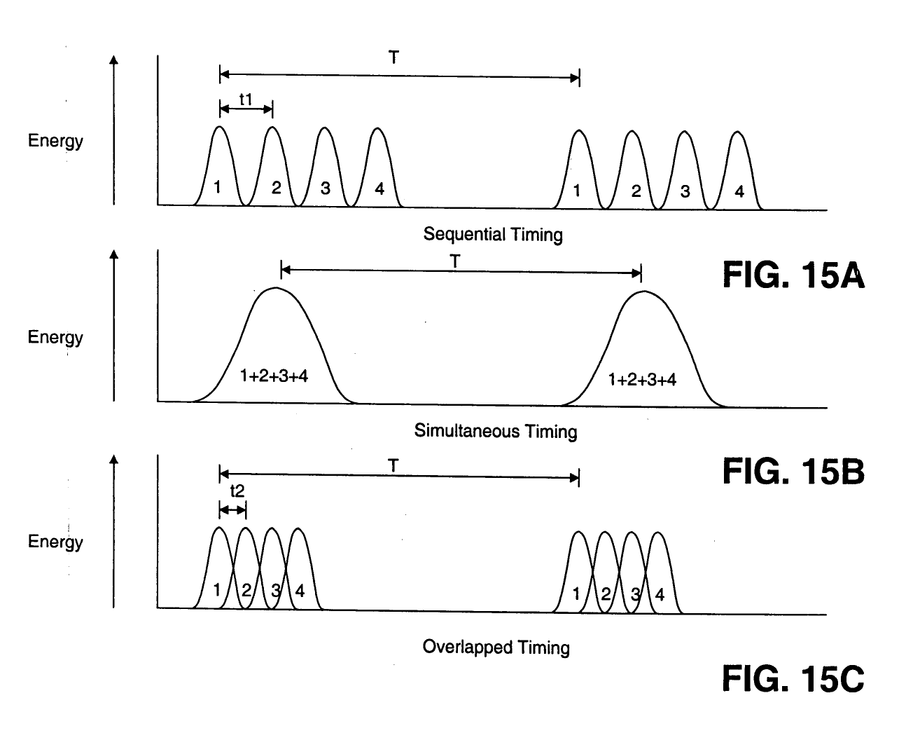

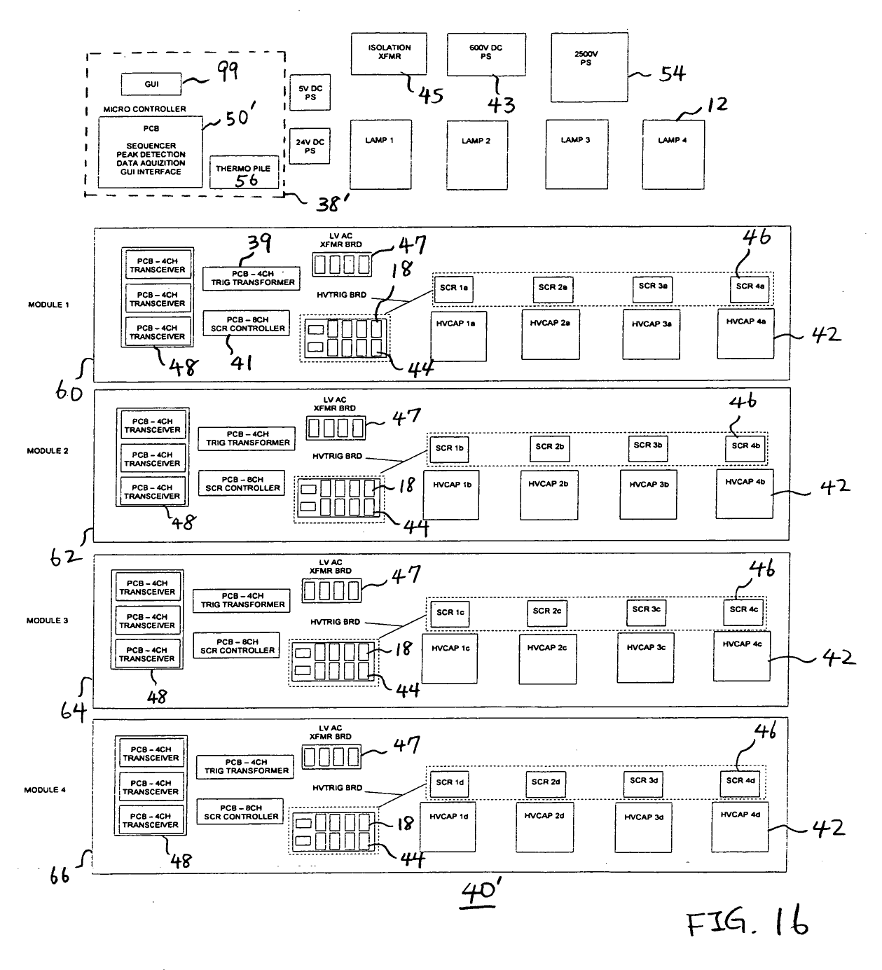

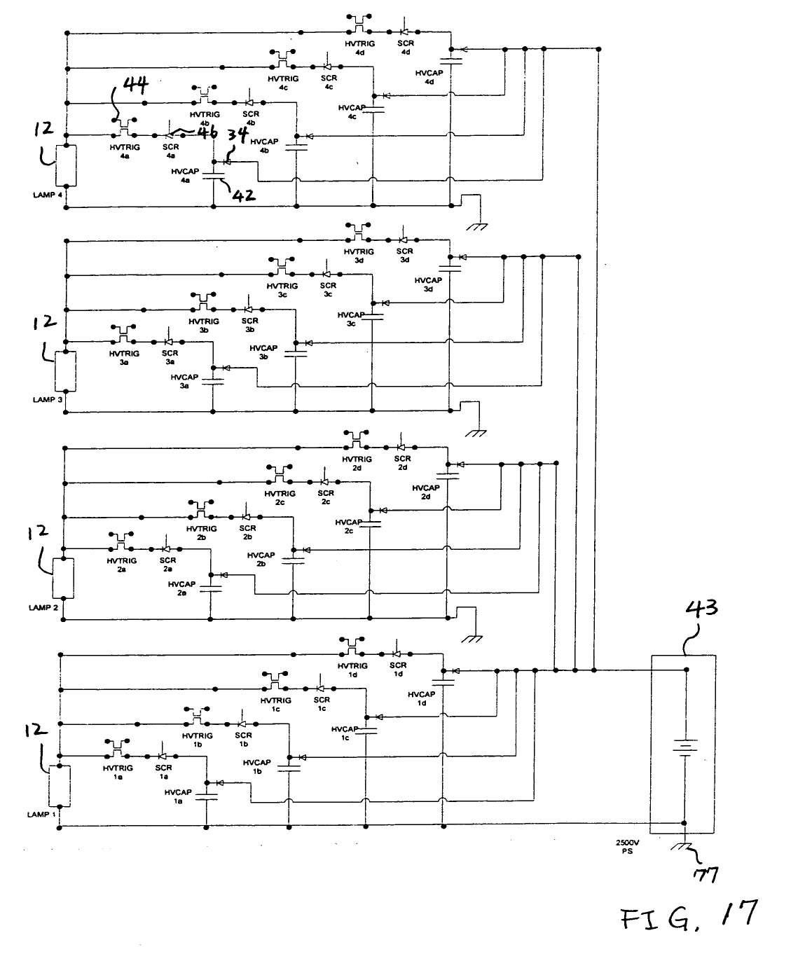

FIG. 15A-15C illustrate light intensity/energy of the respective ultraviolet light generated by the lamps 12 in accordance with the sequencing pattern of light emission of the lamps. Using the microcontroller 50, any of the discharging sequences of FIGS. 15A-15C, or any other desired, suitable discharging sequences may be realized through manual, semi-automatic or automatic programming (using feedback).

It can be seen in FIG. 15A that the lamps 12 are emitted in sequence, one at a time. First, lamps 1, 2, 3 and 4 are emitted in sequence with an interval t1 between the successive emissions. Then, the sequential emission of the lamps 1, 2, 3 and 4 is repeated again. The two successive sequential emissions of four lamps are separated by a period T.

When only one capacitor is used per lamp, as a minimum, the period T in this embodiment is equal to the amount of time required to charge the high voltage capacitor after a discharge to emit light from the corresponding lamp, such that it can be discharged again. In one embodiment, this minimum time T is 15 seconds. When multiple capacitors are used to store charge per lamp, the period T can be reduced significantly. For example, in one embodiment, four capacitors connected in parallel to one lamp can be discharged sequentially within 2 seconds.

As depicted in the energy diagram of FIG. 15A, in one embodiment, the activation of the lamps 12 occurs sequentially. In this case there may be at least a slight delay between the completion of the flash of one lamp 12 and the activation of the flash of the proceeding lamp 12. When the lamps are fired successively as opposed to being fired simultaneously or concurrently, the system experiences less noise.

FIG. 15B illustrates the sequencing of light emissions in which all four lamps are emitted substantially simultaneously or concurrently, such that the graph of FIG. 15B does not indicate four separate discharges. As depicted in the energy diagram of FIG. 8B, the light emission of the plurality of lamps 12 is run substantially simultaneously for all the lamps 12 in the system. In this case, the delay time between the lamps is set to substantially 0 second.

In one embodiment, since the high voltage capacitors corresponding to the lamps are individually and independently charged, the minimum time interval between the two successive discharges (i.e., UV light emissions) is T, which is the same as for the case of FIG. 15A. By using multiple lamps that are emitted concurrently rather than a single lamp having higher intensity at significantly higher price, cost savings can be realized for the flash lamp discharge system.

The light emission sequence of FIG. 15C is similar to the light emission sequence of FIG. 15A, except that the UV light emissions from the lamps are partially overlapped in time with adjacent UV light emissions. Hence, the time t2 between two successive light emissions is less than that of the time t1 of FIG. 15A. However, in this embodiment, the minimum time required for two successive emissions of the same lamp is still T, which is the same as the time required for two successive emissions of the same lamp in FIGS. 15A and 15B.

As depicted in the energy diagram of FIG. 15C, in one embodiment, the light emissions from the lamps 12 partially overlap. Before the light emission (i.e., flash) of one lamp 12 is completed, the light emission of the next lamp begins. Hence, the energy level within the system 10 does not reach 0 until all of the plurality of lamps 12 have flashed. This way, the total energy is kept at higher average level than the sequence of FIG. 8A.

As can be seen in FIGS. 15A-15C, when only a single high voltage capacitor is used to store charge per lamp, there is an unavoidable delay of recharging time, which is the time interval T in the embodiment of FIGS. 15A-15C. By way of example, in one embodiment where a high voltage capacitor has a capacitance of 1450 micro-Farad (μF), it takes a long period of time (e.g., T=4 seconds) to charge the capacitor, and takes a very brief amount of time (e.g., 4 ms) to discharge the capacitor and deliver energy to the lamp. As discussed above, the discharge of the trigger capacitor 18 is initiated through the high voltage trigger transformer (HVTRIG) 44 which places a high voltage (e.g., 20 KV or more) across the electrodes of the lamp for an instant (or a short period of time).

With the charging time of 4 seconds for the high voltage capacitor 42, if a lamp is to be flashed more than once in a time span shorter than 4 seconds, one capacitor is not adequate to charge the capacitor in time for the next emission. It may be possible to devise a quicker way of recharging a single capacitor so that it can be ready to deliver its energy into the lamp. However, such solution may not be optimum in some cases due to cost, size and availability.

In one embodiment, other sources of energy are used to provide energy to the lamp in addition to a single high voltage capacitor. The other energy sources may also be substantially identical high voltage capacitors. Hence, several energy storage devices (i.e., high voltage capacitors) can be charged at one time (or at different times) and then be discharged at different times independently of one another in order to create the desired exposure process.

FIG. 16 is a schematic block diagram of a flash lamp discharge system 40′ with multiple storage capacitors (i.e., high voltage capacitors 42) for each lamp 12, according to one embodiment. The flash lamp discharge system 40′ is similar to the flash lamp discharge system 40 of FIG. 9. A primary difference is that the flash lamp discharge system 40′ includes four modules 60, 62, 64 and 66 (i.e., modules 1 to 4), each module including an energy storage unit and an energy delivery unit. Since the electrical connections between the components of the flash lamp discharge system 40′ are substantially the same as the corresponding electrical connections between the components of the flash lamp discharge system 40, they will not be described again in order to avoid the redundancy of description.

Further, operation of the flash lamp discharge system 40′ is substantially the same as the operation of the flash lamp discharge system 40, except that multiple high voltage capacitors 42 are electrically coupled to each lamp via a corresponding one of the SCRs. The SCRs are controlled by the microcontroller 50′ to select which one of the high voltage capacitors 42 is to be discharged for each of the lamps at any given time when the lamp flashing is desired. Hence, in this embodiment, the microcontroller 50′ not only determines how the intervals between the ultraviolet radiation emissions of the lamps, but also controls which of the high voltage capacitors 42 coupled to each lamp is discharged at any given time when the lamp is to be flashed. The microprocessor 50′ is similar to the microprocessor 50 of FIG. 9, except that it has an added functionality to select charging and discharging of multiple high voltage capacitors providing energy to each lamp, as those skilled in art would appreciate.

In the embodiment of FIG. 16, each lamp 12 is electrically connected to multiple high voltage capacitors 42. By way of example, the module 1 (60) includes substantially all the elements of the module 1 of FIG. 9. The lamp 4 (12) is electrically coupled to and receives energy for light emission from four high voltage capacitors 4a, 4b, 4c and 4d, respectively included in the energy storage unit of the modules 1 to 4 (60, 62, 64, 66). In this configuration, several high voltage capacitors 42 (i.e., four high voltage capacitors) that are electrically coupled to the same lamp can be charged at one time and then discharged at different times independently of the other high voltage capacitors 42. This allows for a system where one high voltage capacitor 42 can be discharging to emit ultraviolet radiation from a lamp while another high voltage capacitor 42 electrically coupled to the same lamp is fully charged or is charging.

Therefore, each of the lamps 12 can be activated at a more rapid pace then if the lamp 12 sat idle during the period that the single high voltage capacitor 42 was being charged. One skilled in the art would appreciate that each module can include as many high voltage capacitors 42 as needed to attain intended intervals between a desired number of lamp flashings or shots.

In one embodiment, the flash lamp discharge system 40′ is a modular system, which allows the user to add any suitable desired number (e.g., optimal number) of high voltage capacitors 42 as necessary without wasting efficiency with additional unneeded high voltage capacitors 42. Hence, the modularized architecture of the capacitor banks result in a scaleable system where high voltage capacitors can be added as needed by adding additional capacitor banks or modules. Further, the amount of energy stored in the high voltage capacitor 42 can be varied depending on the intensity level of the ultraviolet radiation to be emitted by the lamp 12.

In one embodiment, the SCR 46 is used to control the selection of the high voltage capacitor 42 to be discharged. In one embodiment, each high voltage capacitor 42 is electrically connected to a corresponding one of the SCRs 46 to keep it from discharging out of order. The SCR 46 includes a gate control pin which in this embodiment requires that a minimum voltage potential be supplied to it with respect to the cathode of the SCR 46 in order to turn it on.

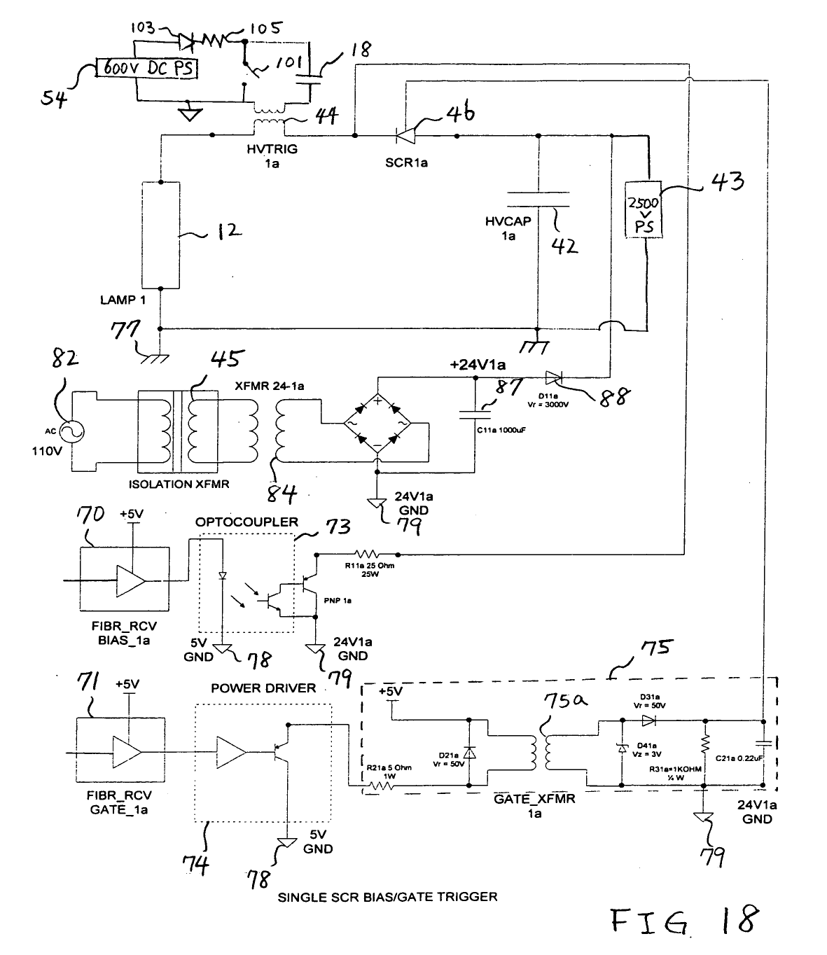

FIG. 17 is a schematic partial circuit diagram of four modules, each module including an energy storage unit and an energy delivery unit for discharging four lamps, in a flash lamp discharge system, according to one embodiment. As can be seen by comparing FIGS. 14 and 17, the circuitry of the modularized architecture of FIG. 17 is substantially the same as the single module architecture of FIG. 14, except that each of the lamps 12 can receive energy from four high voltage capacitors 42. For example, the fourth lamp (lamp 4) 12 can receive energy from four high voltage capacitors (4a, 4b, 4c and 4d) 42, each contained in a different module.

Each lamp 12 is also coupled to four high voltage trigger transformers 44 and four SCRs 46. For example, the fourth lamp (lamp 4) 12 is electrically connected to the high voltage trigger transformers (4a, 4b, 4c, 4d) 44 that are respectively coupled to four SCRs (4a, 4b, 4c, 4d) 46. This way, four different high voltage trigger transformers 44 can be used to trigger or initiate each lamp and four different SCRs 46 can be used to discharge the respective one of the four high voltage capacitors 42.

FIG. 18 is a schematic circuit diagram of an SCR bias/gate trigger circuit in one embodiment in accordance with the present invention. It can be seen in FIG. 18 that the lamp 12 is electrically connected between earth ground and the secondary coil of the high voltage trigger transformer 44. The SCR 46 has the cathode electrically connected to the secondary coil of the high voltage trigger transformer 44 and the anode electrically connected to a first electrode (i.e., high potential end) of the high voltage capacitor 42. A second electrode (i.e., low potential end) of the high voltage capacitor 42 is also electrically connected to the earth ground. The high voltage capacitor 42 is charged using the 2500V power source 43.

The primary coil of the high voltage trigger transformer 44 is coupled to a transformer trigger circuit including the trigger capacitor 18, a trigger switch 101, a diode 103 and a resistor 105. While the trigger switch 101 is open, the 600V DC power source 54 charges the trigger capacitor 18 via the diode 103 and the resistor 105. When the trigger switch 101 closes in response to the lamp trigger signal, the current flow through the primary coil of the high voltage trigger transformer 44 changes rapidly. This creates a high voltage pulse (e.g., 20,000V to 30,000V) at the secondary coil of the high voltage trigger transformer 44, thereby applying a high voltage across the electrodes of the lamp 12.

The gate of the SCR 46 is electrically connected to a gate trigger circuit including a fiber receiver gate 71, an opto-coupler 74 and a transformer circuit 75. The gate trigger circuit is implemented on the trigger transformer circuit 39 (see FIG. 9). The fiber receiver gate 71 receives a gate trigger signal from the microcontroller 50 (or 50′) and provides the trigger signal to a power driver 74. The power driver 74 drives the gate transformer circuit 75.

The gate transformer circuit 75 includes a gate transformer 75a for providing a gate trigger signal to the gate of the SCR 46 based on the input received from the power driver 74. On the input side, the transformer circuit includes a resistor R21a (e.g., 5Ω, 1 Watt resistor) in the signal path, and a diode D21a (e.g., a diode with maximum reverse voltage Vr=50V) that is electrically connected in parallel across the primary coil. The gate trigger signal is provided by the power driver 74 to a first end of the resistor R21a. The primary coil is coupled between a +5V power source and a second end of the resistor R21a.

On the output side, a Zener diode D141a is coupled in parallel with a secondary coil. In one embodiment, the Zener diode has a Zener breakdown voltage Vz of 3V so as to keep the maximum voltage at the input of a diode D31a (e.g., Vr=50V) at +3V. The diode D31a is electrically connected to a first end of the secondary coil, and connected in series with a resistor R31a (e.g., 1KΩ, ¼ Watt resistor) and a capacitor C21a (e.g., 0.22 μF capacitor) that are arranged in parallel with each other. Those skilled in the art would appreciate the operation of the transformer circuit 75.

The first electrode of the capacitor C21a is electrically connected to the gate of the SCR 46 to apply the gate trigger signal. A second electrode of the capacitor C21a is electrically connected to a 24V ground 79, which is different from the 5V ground 78. An SCR bias voltage is created from a separate biasing circuit, which is used to supply the SCR bias voltage at the cathode of the SCR 46.

Referring now to FIGS. 9, 16 and 18, a fiber receiver bias port 70 is used to receive a bias signal from the microcontroller 50 (or 50′) through the 12-channel transceiver circuit 48. The bias signal is provided to an input of an opto-coupler 73. On the input side of the opto-coupler 73, the 5V ground 78 is used as the ground, however, on the output side, 24V ground 79 is used as the ground. In one embodiment, the opto-coupler 73 functions as a level shifter for changing the TTL level of the input voltage to a higher level (i.e., 24V). The output of the opto-coupler 73 is provided to the cathode of the SCR 46 via a resistor R11a, which is a 25Ω, 25 Watt resistor in one embodiment.

The bias circuit also includes the isolation transformer 45 with an AC voltage from an 110V ac voltage source 82 electrically connected across its primary coil. The isolation transformer 45 is used to isolate the input ac voltage from the output side. Further, the output of the isolation transformer 45 is applied to another transformer 84, which is used to convert the input voltage from 110V AC to a lower voltage (e.g., 28V AC). The output of the transformer 84 is rectified by a rectifier 86 to generate a +24V output. A capacitor 87 is also electrically connected between the +24V output and the 24V ground 79. A first electrode of the capacitor 87 (e.g., high potential end) is coupled to an input of a diode 88 (e.g., diode having a reverse voltage Vr of 3000V). An output of the diode 88 is electrically connected to the first electrode of the high voltage capacitor 42. The isolation transformer 45 floats the bias circuit. Even though the capacitor 87 is connected to the high voltage capacitor 42, since the capacitor 87 is not grounded to earth ground, it is seen as floating “broken” circuit to the high voltage system.

Hence, a floating bias potential is created across the SCR 46, using the SCR biasing circuit that is completely separate from the SCR gate trigger circuit (including the gate transformer circuit 75). This way, the bias circuit allows for a creation of a potential difference across the silicon controlled rectifier 46 without reference to earth ground.

While the lamp (LAMP 1) 12 in FIG. 18 is shown as being coupled to only one high voltage trigger transformer (HVTRIG 1a) 44, only one SCR (SCR 1a) 46, only one high voltage capacitor (HVCAP 1a) 42, only one gate transformer circuit (GATE_XFMR 1a) 75, and only one bias circuit, the lamp 12 may be coupled to two or more of each of the high voltage trigger 44, the SCR 46, the high voltage capacitor 42, the gate transformer circuit 75, and the bias circuit contained in corresponding two or more modules (of a modular architecture flash lamp discharge system), as described above in reference to FIGS. 16 and 17. This way, multiple high voltage capacitors 42 and multiple high voltage trigger transformers 44 can be used independently to flash the lamp 12, such that the time delay between two successive emission of ultraviolet light from the lamp 12 can be reduced.

In another embodiment, a separate biasing circuit is not used, and the second electrode of the capacitor C21a may be electrically connected to the cathode of the SCR 46. This way, in one embodiment where the trigger voltage is +3V, when the voltage charged in the capacitor C21a is greater than or equal to 3 Volts, the voltage difference between the gate and the cathode of the SCR 46 becomes greater than or equal to 3V, and therefore the SCR is triggered to allow the energy stored in the high voltage capacitor 42 to be applied to the lamp 12 to flash the lamp.

The usefulness of the exposure system in one embodiment is its ability to accurately deliver a given amount of energy on the substrate (or a panel) placed in the exposure plane. The translation or determination of the required energy output from the exposure system to the number of times to flash and the time delays (time delays between the successive flashing of the first lamp and between the first, second, third and fourth lamps) is performed by the data acquisition and process control unit 38 (or 38′), and in particular the microcontroller 50 (or 50′). This translation involves a two step process where the expected energy output is theoretically calculated by the system in the first step and it is verified in the second step with a feedback mechanism. This is achieved in one embodiment by an active feedback mechanism that is implemented using thermopile sensors, high speed analog to digital converters and microcontroller circuits.

In one embodiment, the energy output of the exposure system is depicted in joules. Equation 1 below is used for computing the expected optical energy output of the system with the electrical energy stored in the capacitors:

E_{OPTICAL}=E_{Elec}×E_{Conv}×E_{IBW}×E_{coil}×E_{Opt} (Equation 1)

where E_{Elec}=½CV² Joules (where C is the value of the high voltage capacitor 42 and V is the voltage charged in the high voltage capacitor 42); E_{Conv} is conversion efficiency; E_{IBW} is percentage of bandwidth of interest; E_{Coil} is percentage of radiation collected by optics; and E_{Opt} adjusts the energy output for less than peak efficiency of operation.

Referring back to FIG. 2, in one embodiment, the flash lamp exposure system 9 further includes at least one detector 28, which detects the actual energy incident on the exposure plane 20. In one embodiment, the at least one detector 28 includes one or more thermopiles or thermopile sensors (e.g., thermopile sensor 56 of FIG. 9). The thermopile sensors are placed around the exposure plane 20, and convert detected heat energy into voltage output. The value of incident energy on the exposure plane 20 per square centimeter or square inch is computed using the following equation Equation 2:

E_{ExpArea}=((V_{Therm}/V_{perJoule})/A_{Topen})×A_{Exp}, (Equation 2)

where E_{ExpArea} is Energy incident on Exposure area; V_{Therm} is thermopile voltage output; V_{perJoule} is Volt per Joule specification of the thermopile; A_{Topen} is Area of the opening for the light to enter into the thermopile; and A_{Exp} is Area of Exposure plane.

In other embodiments, one or more photo sensors are used in the detector 28 instead of or in addition to the thermopiles. Instead of detecting heat as the thermopiles do, the photo sensors are used to measure the intensity of light generated by the lamps when they flash. In either case, the detector 28 is used to create a feedback loop, such that intensity of the exposure can be adjusted to match the desired value (which may have been initially calculated). Such feedback loop based adjustment counters for lamp degradation over time, for example.

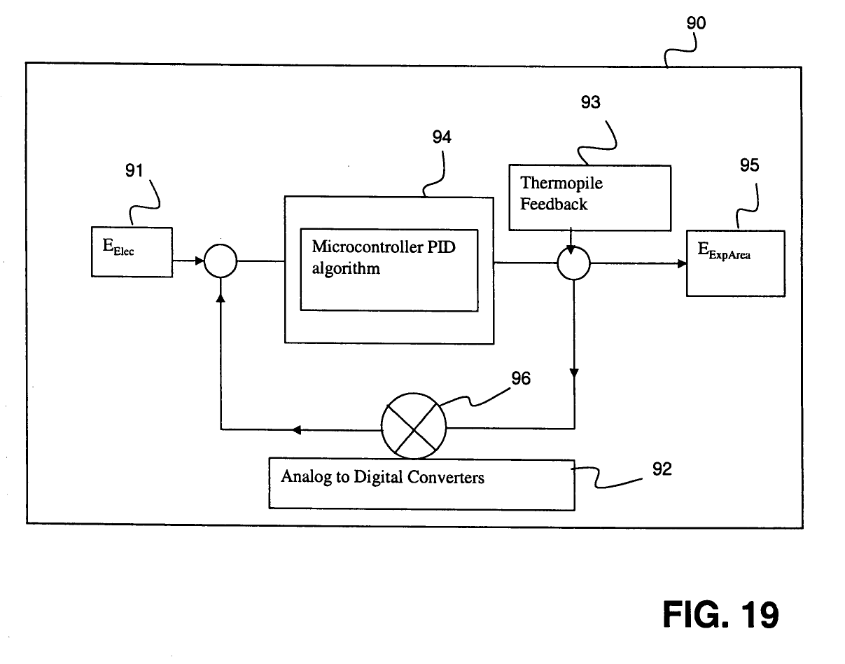

FIG. 19 is a schematic block diagram of an embodiment of an energy management system (or an energy management control system) 90 for the flash lamp discharge system. In one embodiment, the control unit 16 of FIG. 2 includes the energy management system 90. Further, the energy management system 90 may be implemented using the data acquisition and process control unit 38 (or 38′). In one embodiment, the energy management system 90 forms a control system loop that maintains substantial consistency of the energy output incident on the exposure plane 20.

The energy management system 90 includes high-speed analog-to-digital converters 92 that are capable of profiling the output of the detector 28, which is active for the flash time (e.g., 4 milliseconds) of each lamp 12. The output of the detector 28 is shown, for example, as thermopile feedback 93.

The data received by the high-speed analog to digital converters 92 is then used by a PID algorithm 94 running in the microcontroller 50 (or 50′) to compute the error in the required output energy and to adjust the energy stored in the capacitors to be supplied for subsequent flashes. In one embodiment, this is a constantly adjusting mechanism that learns and adjusts to the variations in the system conditions. Here, P=proportional gain, I=integral gain, and D=derivative gain. These are standard “gains”, values which can be adjusted by a user in a system with a feedback correction loop. Gains determine the intensity of correction. Hence, based on the thermopile feedback 93, the energy applied at the exposure area E_{ExpArea} 95 is adjusted. A correction circuit 96 is an error correction signal generator that takes the thermopile feedback 93, creates an error signal and sends into the microcontroller PID algorithm 94 as a command signal.

Given the high speed nature of the data acquisition, two separate circuits can be used to capture and store the data. In addition to being able to “sample” the data at a high rate using ADC (a first circuit), a peak detection circuit (a second circuit) can be used to capture the peak energy value. One of ordinary skill in the art would appreciate that microcontroller 50 (or 50′) can have both or either of the functions of peak detection and data acquisition (using ADC). The peak detection may be useful where the ADC is not fast enough to take the profile of the lamp flashing within 4 ms, since the peak detection circuit only needs to detect the peak voltage.

In one embodiment, the microcontroller 50 (or 50′) is used to process the data and translate it into a form that is understandable to the user. The microcontroller 50 (or 50′) is programmed to communicate with a user interface module via a communication protocol, for example an Ethernet protocol. In one embodiment, the user interacts with a graphical user interface (GUI) based computer program, which sends the data input by the user to the microprocessor 50 (or 50′) via the GUI 99, which may be through an Ethernet port. The use of the microcontroller coupled with Ethernet allows the flash lamp to be applied to communicate with a variety of other systems. In one embodiment, a host machine sends a few commands to the microcontroller 50 (or 50′) via Ethernet, and the microcontroller will take over the process from that point on.

FIG. 20 is a flow diagram illustrating application of ultraviolet radiation to a substrate, according to one embodiment. The flow diagram of FIG. 20 will be described in reference to FIGS. 16 and 18. The ultraviolet light exposure system in one embodiment can be used simply by inputting the desired total energy output (150), for example, by using the GUI 99 of FIG. 16. In other embodiments, additional parameters such as the number of lamps, sequence, delays and light intensity of the lamps can be entered by the user as inputs into the system using GUI or any other suitable input device or devices.

The ultraviolet light exposure system includes a flash lamp exposure system that includes a flash lamp discharge system in addition to primary, secondary and tertiary reflectors and vanes. The flash lamp discharge system 40′ of FIG. 16 includes the microcontroller 50′ that calculates the number and sequence of lamp flashing, delays between lamp flashings and light intensity of the lamps during each flashing (152).

According to the calculations, high voltage capacitors 42 are charged to a suitable voltage (e.g., 2,500V) as needed (153). Suitable voltages (e.g., 600V) are also charged in the trigger capacitors 18.

The microcontroller 50′ provides biasing signals to the 8-channel SCR controller circuit 41 to apply biasing voltages to the next SCR 46 (or the first SCR) in sequence (154) using the biasing circuit illustrated in FIG. 18. Then the microcontroller 50′ provides a gate trigger signal to the 8-channel SCR controller circuit 41, such that the biased SCR 46 is triggered (156) using the gate transformer circuit 75 of FIG. 18.

The microcontroller 50′ also provides the lamp trigger signal to the trigger transformer circuit 39 to apply a high voltage (e.g., 20,000V to 30,000V) to the lamp using the high voltage trigger transformer 44 (158). This way, the lamp 12 is initiated or triggered to conduct electricity, and the energy charged in the high voltage capacitor 42 is discharged through the lamp 12.

The flash lamp discharging system also includes the thermopile 56 to detect the output energy level of the lamp 12 (160). In other embodiments, the output energy level may be detected using a photo detector, a photo sensor or any other suitable energy sensor known to those skilled in the art. If the detected energy level is proper (or desired) (162), the process continues. However, if the detected energy level is different from the expected energy level, adjustments are made to the calculations (154) to adjust one or more of the voltage charged in the high voltage capacitor 42 (i.e., light intensity), delays, number and sequence of lamps, etc. This way, proper (or desired) amount of energy can be applied to the substrate.

If the sequence of lamp flashings has ended (166), the flash lamp discharging process is terminated (168). If not, the process continues by charging or adjusting charges in high voltage capacitors as needed (153) and biasing the next SCR in sequence (154) and continues with the flashing of next lamp(s) in sequence until the end of the sequence is reached (168).

The preceding illustrates the principles of the present invention without limiting the invention thereto. It will thus be appreciated that those skilled in the art will be able to devise various arrangements which, although not explicitly described or shown herein, embody the principles of the invention and are included within its scope and spirit. Furthermore, all examples and conditional language recited herein are principally intended expressly to be only for pedagogical purposes and to aid in understanding the principles of the invention and the concepts contributed by the inventors to furthering the art, and are to be construed as being without limitation to such specifically recited examples and conditions.

Moreover, all statements herein reciting principles, aspects, and embodiments of the invention, as well as specific examples thereof, are intended to encompass both structural and the functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the embodiments shown and described herein, but rather is intended to cover any changes, adaptations or modifications that are within the scope of the invention, as defined by the appended claims.

What is claimed is:

1. A flash lamp exposure system for exposing a substrate to ultraviolet radiation, the system including at least one flash lamp, each flash lamp comprising:
at least one lamp for emitting ultraviolet radiation in response to a voltage;
at least one first reflector, each first reflector being adapted to reflect the ultraviolet radiation toward the substrate;
a second reflector surrounding a path of the ultraviolet radiation from the at least one lamp to the substrate, the second reflector being adapted to reflect first rays of the ultraviolet radiation toward the substrate; and
a third reflector disposed closer to the substrate than the secondary reflector and surrounding the path of the ultraviolet radiation from the at least one lamp to the substrate, the third reflector being adapted to reflect second rays of the ultraviolet radiation toward the substrate.

2. The flash lamp exposure system of claim 1, wherein the third reflector is adapted to reflect at least some of the first rays of the ultraviolet radiation toward the substrate.

3. The flash lamp exposure system of claim 1, wherein the second reflector has a shape of a cut-off pyramid having slanted walls that define a first rectangular opening that faces the at least one lamp and a second rectangular opening that faces the substrate, wherein the second rectangular opening is larger than the first rectangular opening.

4. The flash lamp exposure system of claim 3, wherein the third reflector has a plurality of slanted or non-slanted walls that define two openings facing each other, wherein the openings are adapted to allow the ultraviolet radiation to pass from the at least one lamp to the substrate.

5. The flash lamp exposure system of claim 4, further comprising at least one vane disposed between the lamps and an exposure plane in which the substrate is located.

6. The flash lamp exposure system of claim 1, wherein the at least one flash lamp comprises a pair of flash lamps that face each other, such that both sides of the substrate can be exposed to the ultraviolet radiation concurrently.

7. The flash lamp exposure system of claim 1, wherein the at least one lamp comprises a plurality of lamps, and the at least one first reflector comprises a plurality of first reflectors, wherein each of the first reflectors is located adjacent a corresponding one of the lamps.

8. The flash lamp exposure system of claim 1, wherein the at least one lamp comprises a plurality of lamps, wherein the at least one flash lamp further comprises a sequencing mechanism for sequencing light emission of the plurality of lamps.

9. The flash lamp exposure system of claim 8, wherein the sequencing mechanism is adapted to control the plurality of lamps to emit at least one of sequentially, concurrently or in a partially overlapped manner.

10. The flash lamp exposure system of claim 8, wherein the at least one flash lamp further comprises an energy storage unit for storing energy used to apply the voltage to the lamps for emission of the ultraviolet radiation.

11. The flash lamp exposure system of claim 10, wherein the at least one flash lamp further comprises an energy delivery unit for applying the energy stored in the energy storage unit to the lamps.

12. The flash lamp exposure system of claim 11, wherein the energy storage unit includes a plurality of capacitors for storing the energy, and the energy delivery unit includes a plurality of switches, each switch for controlling a corresponding one of the capacitors to discharge to provide the energy to a corresponding one of the lamps.

13. The flash lamp exposure system of claim 12, wherein the plurality of switches comprise a plurality of silicon controlled rectifiers, wherein each of the silicon controlled rectifiers has a cathode, a gate and an anode, and each of the capacitors has a first electrode and a second electrode, and wherein the anode is electrically connected to the first electrode of a corresponding one of the capacitors.

14. The flash lamp exposure system of claim 13, wherein the cathode is electrically connected to a high voltage trigger transformer disposed between the silicon controlled rectifier and the corresponding one of the lamps.

15. The flash lamp exposure system of claim 13, further comprising a biasing circuit for creating a potential difference across the silicon controlled rectifier without reference to an earth ground, prior to applying a trigger signal to the gate of the silicon controlled rectifier.

16. The flash lamp exposure system of claim 8, wherein the at least one flash lamp further comprises one or more modules, each module including an energy storage unit for storing energy for emission of the lamps and an energy delivery unit for applying the stored energy to the lamps, wherein a number of the modules in the at least one flash lamp is adjustable.

17. The flash lamp exposure system of claim 1, wherein the at least one flash lamp further comprises means for detecting energy of the ultraviolet radiation, and means for using the detected energy to adjust energy output of the flash lamp exposure system.

18. A flash lamp for applying ultraviolet radiation to a substrate, the flash lamp comprising:
a plurality of lamps for generating the ultraviolet radiation;
at least one reflector for directing the ultraviolet radiation to the substrate;
an energy storage unit for storing energy used to generate the ultraviolet radiation;
an energy delivery unit for applying the stored energy to the lamps to generate the ultraviolet radiation; and
a sequencer for controlling timing of light emission by the lamps.

19. The flash lamp of claim 18, wherein the flash lamp further comprises means for detecting energy of the ultraviolet radiation, and means for using the detected energy to adjust intensity of the ultraviolet radiation.

20. The flash lamp of claim 19, wherein the means for detecting energy comprises a thermopile or a photo sensor.

21. The flash lamp of claim 18, wherein the energy storage unit comprises a plurality of capacitors, each of the lamps being adapted to received energy from at least one of the capacitors, wherein the sequencer provides at least one control signal to select at least one of the capacitors used to emit at least one of the lamps.

22. A method of exposing a substrate to ultraviolet radiation generated by a plurality of lamps, the method comprising:
storing energy used to generate the ultraviolet radiation;
applying the stored energy to the lamps to generate the ultraviolet radiation;
detecting energy of the ultraviolet radiation; and
adjusting intensity of the ultraviolet radiation in accordance with the detected energy.

23. The method of claim 22, further comprising determining timing of light emission from the lamps to be at least one of sequentially, concurrently or in a partially overlapped manner.

24. The method of claim 22, wherein said applying the stored energy comprises applying a high voltage to the lamp to initiate the generation of the ultraviolet radiation.

25. The method of claim 24, wherein said applying the high voltage comprises storing a second energy used to generate the high voltage and applying the second energy to a high voltage trigger transformer to generate the high voltage.

26. A flash lamp discharge system comprising:
a lamp for emitting light;
a trigger device for providing sufficient voltage to the lamp to initiate the lamp for light emission, wherein the lamp is located between the trigger device and a first ground;
an energy storage device for storing energy used for the light emission;
a switch located between the lamp and the energy storage device to selectively provide the energy to the lamp; and
a biasing circuit for biasing the switch to prepare the switch to provide the energy to the lamp in response to a trigger signal applied to the switch, wherein the biasing circuit creates a potential difference across the switch without reference to the first ground.
